(19) United States
(12) Patent Application Publication
(10) Pub. No.: US 2017/0045018 A1
(43) Pub. Date: Feb. 16, 2017

(54) STIRLING ENGINE

(71) Applicants: Hidemi KURITA, Nagano-shi, Nagano (JP); Masanori SHIMIZU, Hanishina-gun, Nagano (JP)

(72) Inventor: Hidemi KURITA, Nagano-shi (JP)

(73) Assignees: Hidemi KURITA, Nagano-shi, Nagano (JP); Masanori SHIMIZU, Hanishina-gun, Nagano (JP)

(21) Appl. No.: 15/304,792

(22) PCT Filed: Apr. 13, 2015
(86) PCT No.: PCT/JP2015/061317

§ 371 Date: Oct. 17, 2016

(30) Foreign Application Priority Data
Apr. 18, 2014 (JP) 2014-086054

(51) Int. Cl. F02G 1/055

(52) U.S. Cl. CPC F02G 1/055

(57) ABSTRACT

The displacer 2d . . . has a gas retention space Hg . . . formed therein. The gas retention space Hg . . . enables a working gas G to be alternately moved between a heating unit 3h side and a cooling unit 3c side of a displacer cylinder 2c . . . by the movement of the displacer 2d . . . . The displacer 2d . . . and the displacer cylinder 2c . . . have an outer circumferential surface 2df and an inner circumferential surface 2ci, respectively, formed into such shapes as to be able to permit the movement of the displacer 2d . . . and inhibit passage of the working gas G. The displacer 2d . . . has a gas passageway 7 which is formed on its outer circumferential surface 2df and includes a gas passage groove that allows the gas retention space Hg to communicate with a working gas inlet/outlet 6 . . . provided in the displacer cylinder 2c . . . and connected to a power cylinder 5c.

### TECHNICAL FIELD

The present invention relates to a Stirling engine that is suitably used, for example, in generating electricity with use of various types of heat sources, such as industrial waste heat and solar heat.

### BACKGROUND ART

The oscillating flow regenerative heat engine disclosed in PTL 1 and the rotary Stirling engine disclosed in PTL 2 have conventionally been known as examples of Stirling engines including: a displacer body unit having a displacer cylinder in which a working gas and a movable displacer are accommodated; a cooling and heating working unit having a heating unit that heats a first side of the displacer cylinder and a cooling unit that cools a second side of the displacer; a displacer-driving actuator that moves the displacer; and a power output unit having a power cylinder containing a power piston which is moved by the effect of volume change of the working gas in the displacer cylinder, in particular a Stirling engine whose displacer is a rotary displacer having a circular cylindrical shape and a central axis that rotates.

The oscillating flow regenerative heat engine disclosed in PTL 1 is intended to prevent mixture of gases in a plurality of cycles and to uniformize working gas passageways. Specifically, in an oscillating flow regenerative heat engine such as a Stirling refrigeration machine wherein the working gas is sealed inside of a system composed of a compression space of a compressor, a radiator, a regenerator, a heat absorber, and an expansion space of an expander, and the working gas is oscillated when the volume of the compression space and the volume of the expansion space are periodically changed with a predetermined phase difference in order to achieve a cooling capacity at a predetermined temperature from the heat absorber, the compressor is composed of a housing, rotors rotatably mounted in the internal space of the housing, and a plurality of vanes energized in the radially inward direction of the internal space, having tip end parts slidably kept into contact with outer circumferential surfaces of the rotors at all times, and arranged at predetermined intervals in the circumferential direction, and at least one of a plurality of volume-variable working spaces formed by sectioning the internal space by the rotors and the plurality of vanes is applied as the compression space.

Further, the rotary Stirling engine disclosed in PTL 2 is intended to provide a Stirling engine with high thermal efficiency by reducing wasteful heat flows while a working fluid moves in a γ Stirling engine using a rotary displacer. Specifically, along with the rotary displacer, a heat-absorbing regenerator and a heat-releasing regenerator which are fixed to both ends of a sliding heat pipe are internally placed in a displacement chamber. When the rotary displacer is rotated, the working fluid in the displacement chamber moves through the gap between the heat-absorbing regenerator and the heat-releasing regenerator to exchange heat therebetween. The heat transfer between the heat-absorbing regenerator and the heat-releasing regenerator is performed by the sliding heat pipe. The heat energy stored in the heat-absorbing regenerator is returned from the heat-releasing regenerator to the working fluid after a half cycle to increase the heat efficiency. The collision between the rotary displacer and the heat-absorbing regenerator and the heat-releasing regenerator is avoided by the cam mechanism.

### CITATION LIST

### Patent Literature

PTL 1: Japanese Unexamined Patent Application Publication No. 2006-038251

PTL 2: Japanese Unexamined Patent Application Publication No. 2010-144518

### SUMMARY OF INVENTION

### Technical Problem

However, the conventional Stirling engines described above, in particular the Stirling engines using a rotary displacer, have the following problems:

First, the working gas in the displacement chamber heated by the heating unit needs to efficiently act on the power cylinder, and heat leaks from a heating unit side to a cooling unit side contributes heavily to a decrease in efficiency. For this reason, a structure has conventionally been employed in which the displacement chamber is sectioned by a movable heat pipe, a plurality of displaceable vanes, or the like. However, measures to prevent heat leaks by these movable mechanisms invite an increase in the number of components and structural complication and, furthermore, in cost and size, and additionally require the attachment of an additional movable mechanism unit, hence also disadvantageous in terms of ensuring durability and reliability.

Second, the structure including a movable heat pipe and a plurality of displaceable vanes or the like requires a movable mechanism unit which moves the heat pipe or the plurality of vanes, thus entailing energy consumption for this purpose and causing a measurable overall decrease in energy conversion efficiency. After all, there has also been further room for improvement in structural aspects, in terms of increasing energy conversion efficiency in the Stirling engine.

It is an object of the present invention to provide a Stirling engine with solutions to such problems occurring in the background art.

### Solution to Problem

In order to solve the problems described above, a Stirling engine 1 according to the present invention is disclosed. Sterling engine 1 is a Stirling engine including: a displacer body unit 2 having a displacer cylinder 2c (2ce, 2cs) in which a working gas G and a movable displacer 2d (2de, 2ds) are accommodated; a cooling and heating working unit 3 having a heating unit 3h which heats a first side of the displacer cylinder 2c (2ce, 2cs) and a cooling unit 3c which cools a second side of the displacer cylinder 2c (2ce, 2cs); a displacer-driving actuator 4 that moves the displacer 2d; and a power output unit 5 having a power cylinder 5c containing a power piston 5p that is moved by the effect of volume change of the working gas G in the displacer cylinder 2 (2ce, 2cs), wherein the displacer 2d (2de, 2ds) has a gas retention space Hg (Hgs, Hgse) formed therein, the gas retention space Hg (Hgs, Hgse) enabling the working gas G to be alternately moved between a heating unit 3h side and a cooling unit 3c side of the displacer cylinder 2c (2ce, 2cs) by movement of the displacer 2d (2de, 2ds), the displacer 2d (2de, 2ds) and the displacer cylinder 2c (2ce, 2cs) have an outer circumferential surface 2df and an inner circumferential surface 2ci, respectively, formed into shapes that can permit the movement of the displacer 2d (2de, 2ds) and inhibit passage of the working gas G, and the displacer 2d (2de, 2ds) has a gas passageway 7 which is formed on its outer circumferential surface 2df and includes a gas passage groove that allows the gas retention space Hg (Hgs, Hgse) to communicate with working gas inlet/outlets 6 (6e, 6p) provided in the displacer cylinder 2c (2ce, 2cs) and connected to the power cylinder 5c.

In this case, according to a preferred aspect of the invention, the displacer body unit 2 may include a precisely circular cylindrical rotary displacer 2d whose outer circumferential surface 2df is parallel to an axial direction Fs with respect to a central axis Fc on which the displacer 2d rotates and whose gas retention space Hg is formed by notching a part of the outer circumferential surface 2df, and the heating unit 3h and the cooling unit 3c may be disposed in 180-degree opposed positions, respectively, on an outer surface of the displacer cylinder 2c . . . in a radial direction. Further, the gas passageway 7 may be constituted by a front passageway 7f (7fs) extending from a first end of the gas retention space Hg in a circumferential direction Ff along the circumferential direction Ff of the displacer 2d (2de, 2ds) and a rear passageway 7r (7rs) extending from a second end of the gas retention space Hg in the circumferential direction Ff along the circumferential direction Ff of the displacer 2d (2de, 2ds). In so doing, the front passageway 7f (7fs) and the rear passageway 7r (7rs) may be formed as discontinuous passageways that are independent of each other or as continuous passageways that communicate with each other. It should be noted that the displacer cylinder 2c (2ce, 2cs) may be provided with one or two or more working gas inlet/outlets 6 (6e, 6p). In addition, the displacer cylinder 2c (2ce, 2cs) may have an auxiliary gas passageway 7s (7sm, 7se) formed on a part of the inner circumferential surface 2ci which faces the working gas inlet/outlets 6 (6e, 6p) and including a gas passage groove communicating with the gas passageway 7 across a predetermined range of angles in the circumferential direction Ff. Furthermore, the displacer body unit 2 may include clearance adjustment mechanisms 8x, 8x that are capable of adjusting clearances Sx . . . between both end faces of the displacer 2d (2de) and inner surfaces of ends of the displacer cylinder 2c (2ce, 2cs).

Furthermore, according to a preferred aspect of the invention, the displacer body unit 2 may include a rotary displacer 2de whose outer circumferential surface 2df is tapered with respect to a central axis Fc on which the displacer 2de rotates and whose gas retention space Hg is formed by notching a part of the outer circumferential surface 2df. In addition, the heating unit 3h and the cooling unit 3c may be disposed in 180-degree opposed positions, respectively, on an outer surface of the displacer cylinder 2ce in a radial direction, and the displacer body unit 2 may include position adjustment mechanisms 8y, 8y which are capable of adjusting the position of the displacer 2de in an axial direction Fs with respect to the displacer cylinder 2ce. Further, the inner circumferential surface of the displacer cylinder 2c (2ce, 2cs) may include an inner circumferential surface(s) 2dih and/or 2dic corresponding to the heating unit 3h and/or the cooling unit 3c and formed as a corrugated surface(s) to be larger in actual surface area. In so doing, the corrugated surface(s) may be formed by a plurality of depressed grooves 51hs . . . , 51cs . . . placed at predetermined intervals Ls . . . in an axial direction Fs and extending along a circumferential direction Ff, and some or all of the depressed grooves 51hs . . . , 51cs . . . may have their inner surfaces 52 . . . formed as two-dimensional corrugated surfaces. It should be noted that the inner circumferential surface 2dih of the displacer cylinder 2c (2ce, 2cs) corresponding to the heating unit 3h may be provided with an auxiliary space(s) 9hi and/or 9he formed by notching a first end side and/or a second end side of the displacer cylinder 2c (2ce, 2cs) in a circumferential direction Ff, and the inner circumferential surface 2dic corresponding to the cooling unit 3c may be provided with an auxiliary space(s) 9ci and/or 9ce formed by notching the first end side and/or the second end side of the displacer cylinder 2c (2ce, 2c5) in the circumferential direction Ff. Further, the displacer 2d (2de) may include a stirring mechanism 10 that stirs the content of the gas retention space Hg. Furthermore, the displacer body unit 2 may include a linear displacer 2ds which has a circular cylindrical shape and is displaced forward and backward in an axial direction Fs, and the gas passageway 7 may be provided in the inner circumferential surface of the displacer cylinder 2cs and/or the outer circumferential surface of the displacer 2ds extending in the axial direction Fs. The gas retention spaces Hgs and Hgse may be provided between end faces of the displacer 2ds and inner end faces of the displacer cylinder 2cs, and the heating unit 3h and the cooling unit 3c may be disposed on outer surfaces of end faces of the displacer cylinder 2cs in the axial direction Fs, respectively.

### Advantageous Effects of Invention

The Stirling engine 1 according to the present invention thus configured brings about the following remarkable effects:

(1) The structure of the displacer body unit 2 only needs two basic components, namely the displacer 2d . . . and the displacer cylinder 2c . . . and does not need means such as building a sectioned structure with additional components. Therefore, in particular, even a Stirling engine 1 using a rotary displacer 2d . . . allows the working gas G heated by the heating unit 3h to efficiently act on the power cylinder 5c and, what is more, can contribute to a reduction in cost by reducing the number of components and simplifying the structure, and by extension to a reduction in size and weight. Moreover, the absence of a movable mechanism unit added to the displacer 2d . . . makes it possible to easily ensure durability and reliability.

(2) The gas retention space Hg, which enables the working gas G to be alternately moved between the heating unit 3h side and the cooling unit 3c side of the displacer cylinder 2c . . . by the movement of the displacer 2d . . . , is formed in the displacer 2d . . . , and the outer circumferential surface 2df of the displacer 2d . . . and the inner circumferential surface 2ci of the displacer cylinder 2c . . . are formed into such shapes as to be able to permit the movement of the displacer 2d . . . and inhibit passage of the working gas G. Such an airtight structure makes it possible to effectively inhibit a leak (heat leak) of the working gas G between the heating unit 3h and the cooling unit 3c, thus making it possible to reduce unnecessary loss of energy and increase energy conversion efficiency in the Stirling engine 1 from the structural aspect of the displacer body unit 2. As a result, the Stirling engine 1 can be used even in a case where the heating unit 3h is at a comparatively low temperature, thus making it possible to utilize various heat sources including natural energy such as solar heat and biomass and, furthermore, waste energy such as factory exhaust heat.

(3) According to a preferred aspect, the displacer body unit 2 may include a precisely circular cylindrical rotary displacer 2d whose outer circumferential surface 2df is parallel to an axial direction Fs with respect to a central axis Fc on which the displacer 2d rotates and whose gas retention space Hg is formed by notching a part of the outer circumferential surface 2df, and the heating unit 3h and the cooling unit 3c may be disposed in 180-degree opposed positions, respectively, on an outer surface of the displacer cylinder 2c . . . in a radial direction. This allows the displacer body unit 2 to be most rationally and simply structured from a geometric standpoint. Therefore, this embodiment can be carried out as a most suitable embodiment in terms of building the Stirling engine 1 according to the present invention and achieve most suitable performance in terms of effectively ensuring the working effects of the present invention.

(4) According to a preferred aspect, the gas passageway 7 may be constituted by a front passageway 7f . . . extending from a first end of the gas retention space Hg . . . in a circumferential direction Ff along the circumferential direction Ff of the displacer 2d . . . and a rear passageway 7r . . . extending from a second end of the gas retention space Hg . . . in the circumferential direction Ff along the circumferential direction Ff . . . of the displacer 2d . . . , and the front passageway 7f . . . and the rear passageway 7r . . . may be formed as discontinuous passageways that are independent of each other. The front passageway 7f . . . and the rear passageway 7r . . . , which are independent, bring the flow of the working gas G between the heating unit 3h and the cooling unit 3c into a blocked state, thus making it possible to surely prevent a heat leak through the gas passageway 7 even in a case where the gas passageway 7 is provided in the outer circumferential surface 2df . . . of the displacer 2d. . . .

(5) According to a preferred aspect, the gas passageway 7 may be constituted by a front passageway 7f . . . extending from a first end of the gas retention space Hg . . . in its circumferential direction Ff along the circumferential direction Ff of the displacer 2d . . . and a rear passageway 7r . . . extending from a second end of the gas retention space Hg . . . in the circumferential direction Ff along the circumferential direction Ff . . . of the displacer 2d . . . , and the front passageway 7f . . . and the rear passageway 7r . . . may be formed as continuous passageways that communicate with each other. This generates a small amount of heat leak through the gas passageway 7, but eliminates the switching between the front passageway 7f . . . and the rear passageway 7r . . . to the working gas inlet/outlet 6, thus making it possible to ensure the continuity and stability of the working gas G flowing between the gas passageway 7 and the working gas inlet/outlet 6. This makes it possible to build various embodiments by selecting discontinuous passageways or continuous passageways.

(6) According to a preferred aspect, when the displacer cylinder 2c . . . is provided with one working gas inlet/outlet 6, this embodiment can be carried out as the simplest embodiment. When the displacer cylinder 2c . . . is provided with two or more working gas inlet/outlets 6, the inlets/outlets of the working gas G can be ensured in a plurality of positions. Therefore, the optimization of input and output positions according to various types of embodiment is enabled for a higher degree of freedom in design, and various embodiments can be build, including the choice in volume of the gas retention space Hg . . . and heat-insulating structure, by changing the aspects of the working gas inlet/outlets 6. . . .

(7) According to a preferred aspect, the displacer cylinder 2c . . . may have an auxiliary gas passageway 7s . . . formed on a part of the inner circumferential surface 2ci . . . that faces the working gas inlet/outlet 6 . . . and including a gas passage groove communicating with the gas passageway 7 . . . across a predetermined range of angles in the circumferential direction Ff. This makes it possible to ensure various passageways through a combination of the auxiliary gas passageway 7s . . . and the gas passageway 7 . . . , thus giving the advantage of increasing the degree of freedom in design, including the choice in volume of the gas retention space Hg . . . and heat-insulating structure.

(8) According to a preferred aspect, the displacer body unit 2 may include clearance adjustment mechanisms 8x . . . that are capable of adjusting clearances Sx . . . between both end faces of the displacer 2d (2de) and inner surfaces of ends of the displacer cylinder 2c (2ce, 2cs). This makes it possible to adjust the clearances Sx . . . between both end faces of the displacer 2d (2de) and the inner surface of the ends of the displacer cylinder 2c (2ce, 2cs) to the minimum level, thus giving the advantages of enabling easy optimization of the clearances Sx . . . and contribution to further improvement in performance.

(9) According to a preferred aspect, the displacer body unit 2 may include a rotary displacer 2de whose outer circumferential surface 2df is tapered with respect to a central axis Fc on which the displacer 2de rotates and whose gas retention space Hg is formed by notching a part of the outer circumferential surface 2df, and the heating unit 3h and the cooling unit 3c may be disposed in 180-degree opposed positions, respectively, on an outer surface of the displacer cylinder 2ce in a radial direction. Simultaneously, the displacer body unit 2 may include position adjustment mechanisms 8y, 8y that are capable of adjusting a position of the displacer 2de in an axial direction Fs with respect to the displacer cylinder 2ce. This makes it possible to adjust the position of the displacer 2de in the axial direction Fs and adjust the gap (radial gap) between the outer circumferential surface of the displacer 2de and the displacer cylinder 2ce to the minimum level, thus making it possible to easily optimize the gap and contribute to further improvement in performance.

(10) According to a preferred aspect, the inner circumferential surface of the displacer cylinder 2c (2ce, 2cs) corresponding to the heating unit 3h and/or the cooling unit 3c, i.e. inner circumferential surface(s) 2dih and/or 2dic, may be formed as a corrugated surface(s) to enlarge the actual surface area. This makes it possible to increase the actual heat-transfer area between the heating and/or cooling unit(s) 3h . . . and/or 3c . . . and the working gas G, thus giving the advantage of making it possible to contribute to improvement in heat-exchange efficiency.

(11) According to a preferred aspect, in forming the corrugated surface(s), the corrugated surface(s) may be formed by a plurality of depressed grooves 51hs . . . , 51cs . . . placed at predetermined intervals Ls . . . in an axial direction Fs and extending along a circumferential direction Ff. This makes it possible to advance the heating starting timing, in addition to increasing the actual surface area with the corrugated surface(s), thus making it possible to further increase heat-exchange efficiency.

(12) According to a preferred aspect, some or all of the depressed grooves 51hs . . . , 51cs . . . may have their inner surfaces 52 . . . formed as two-dimensional corrugated surfaces. This makes it possible to further increase the actual heat-transfer area between the heating and/or cooling unit(s) 3h . . . and/or 3c . . . and the working gas G, thus making it possible to contribute to further improvement in heat-exchange efficiency.

(13) According to a preferred aspect, the inner circumferential surface of the displacer cylinder 2c (2ce, 2cs) corresponding to the heating unit 3h, i.e. inner circumferential surface 2dih, may be provided with an auxiliary space(s) 9hi and/or 9he formed by notching a first end side and/or a second end side of the displacer cylinder 2c in a circumferential direction Ff, and an inner circumferential surface 2dic corresponding to the cooling unit 3c may be provided with an auxiliary space(s) 9ci and/or 9ce formed by notching the first end side and/or the second end side of the displacer cylinder in the circumferential direction Ff. This makes it possible to enforce heating and cooling at the start and/or end of heating and the start and/or end of cooling, thus making it possible to contribute to improvement in heat-exchange efficiency.

(14) According to a preferred aspect, the displacer 2d may include a stirring mechanism 10 that stirs the content of the gas retention space Hg. This makes it possible to stir the working gas G in the gas retention space Hg, thus making it possible to contribute to further improvement in heat conversion efficiency.

(15) According to a preferred aspect, the displacer body unit 2 may include a linear displacer 2ds that has a circular cylindrical shape and is displaced forward and backward in an axial direction Fs, and the gas passageway 7 may be provided in the inner circumferential surface of the displacer cylinder 2cs and/or the outer circumferential surface of the displacer 2ds and extends in the axial direction Fs. Simultaneously, the gas retention spaces Hgs and Hgse may be provided between end faces of the displacer 2ds and inner end faces of the displacer cylinder 2cs, and the heating unit 3h and the cooling unit 3c may be disposed on outer surfaces of end faces of the displacer cylinder 2cs in the axial direction Fs, respectively. Even when the Stirling engine 1 uses the linear displacer 2ds, the Stirling engine 1 can bring about certain working effects based on the gas passageway 7 provided according to the present invention.

### BRIEF DESCRIPTION OF DRAWINGS

FIG. 1 is a cross-sectional front view theoretically showing an internal structure of a Stirling engine according to a preferred embodiment of the present invention.

FIG. 2 is a cross-sectional bottom view theoretically showing the internal structure of the Stirling engine.

FIG. 3 is a cross-sectional side view theoretically showing the internal structure of the Stirling engine.

FIG. 4 is a perspective view of a displacer in the Stirling engine.

FIG. 5 is an explanatory diagram describing the steps of operation of the Stirling engine.

FIG. 6 is an explanatory diagram of steps of operation pertaining to another method of operating the Stirling engine.

FIG. 7 is a flow chart for explaining the operation of the Stirling engine.

FIG. 8 is a cross-sectional front view theoretically showing an internal structure of a Stirling engine according to a modified embodiment of the present invention.

FIG. 9 is a cross-sectional front view theoretically showing an internal structure of a Stirling engine according to another modified embodiment of the present invention.

FIG. 10 is a cross-sectional front view theoretically showing an internal structure of a Stirling engine according to another modified embodiment of the present invention.

FIG. 11 is a perspective view of a displacer in a Stirling engine according to another modified embodiment of the present invention.

FIG. 12 is a cross-sectional side view theoretically showing an internal structure of a Stirling engine according to another modified embodiment of the present invention.

FIG. 13 is a cross-sectional side view theoretically showing an internal structure of a Stirling engine according to another modified embodiment of the present invention.

FIG. 14 is a cross-sectional side view theoretically showing an internal structure of a Stirling engine according to another modified embodiment of the present invention.

FIG. 15 is a cross-sectional front view theoretically showing an internal structure of a Stirling engine according to another modified embodiment of the present invention.

FIG. 16 is an internal structural diagram theoretically showing a Stirling engine according to a modification of the modified embodiment shown in FIG. 15.

FIG. 17 is a cross-sectional shape diagram showing a partial enlargement of a structure according to a modification obtained by changing a part of the Stirling engine shown in FIG. 16.

FIG. 18 is a cross-sectional shape diagram showing a partial enlargement of a structure according to another modification obtained by changing a part of the Stirling engine shown in FIG. 16.

FIG. 19 is a cross-sectional front view theoretically showing an internal structure of a Stirling engine according to another modified embodiment of the present invention.

FIG. 20 is a cross-sectional side view theoretically showing an internal structure of a Stirling engine according to another modified embodiment of the present invention.

### REFERENCE SIGNS LIST

1: Stirling engine, 2: displacer body unit, 2d (2de, 2ds): displacer, 2c (2ce, 2cs): displacer cylinder, 2ds: linear displacer, 2df: outer circumferential surface of displacer, 2ci: inner circumferential surface of displacer cylinder, 2ce: displacer cylinder, 2dih: inner circumferential surface corresponding to heating unit, 2dic: inner circumferential surface corresponding to cooling unit, 3: cooling and heating working unit, 3h: heating unit, 3c: cooling unit, 4: displacer-driving actuator, 5: power output unit, 5p: power piston, 5c: power cylinder, 6(6e, 6p): working gas inlet/outlet, 7: gas passageway, 7f (7fs): front passageway, 7r (7rs): rear passageway, 7s (7sm, 7se):auxiliary gas passageway, 8x: clearance adjustment mechanism, 8y: position adjustment mechanism, 9hi: auxiliary space, 9he: auxiliary space, 9ci: auxiliary space, 9ce: auxiliary space, 10: stirring mechanism, 51hs . . . : depressed groove, 51cs . . . : depressed groove, 52 . . . : inner surface of depressed groove, G: working gas, Hg(Hgs, Hgse): gas retention space, Fc: central axis, Fs: axial direction, Ff: circumferential direction, Sx . . . : clearance, Ls . . . : predetermined interval

### DESCRIPTION OF EMBODIMENTS

The best embodiment of the present invention is described in detail below with reference to the drawings.

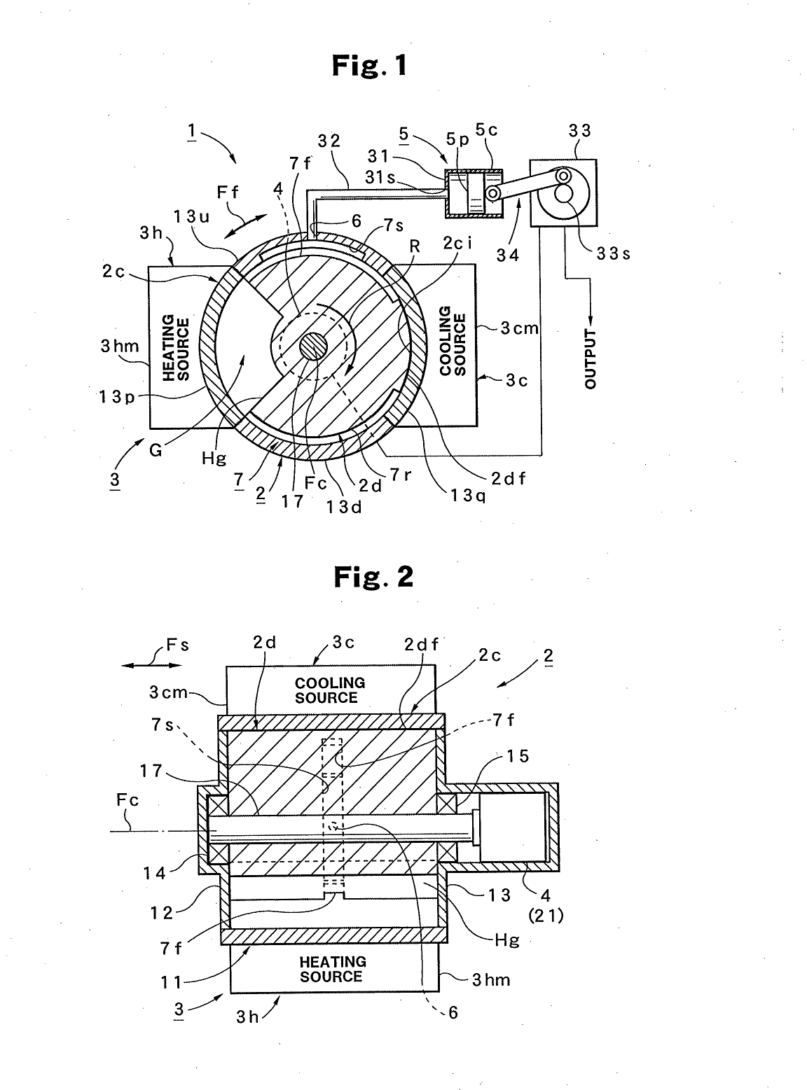

First, a configuration of a Stirling engine 1 according to the present embodiment (basic embodiment) is described with reference to FIGS. 1 to 4.

As shown in FIGS. 1 and 2, a basic configuration of the Stirling engine 1 according to the present embodiment roughly includes a displacer body unit 2, a cooling and heating working unit 3, a displacer-driving actuator 4, and a power output unit 5.

The displacer body unit 2 includes a displacer cylinder 2c in which a working gas G is accommodated and a displacer 2d is rotatably (movably) accommodated. The working gas G is not limited to any particular gas; however, the working gas G may be gases such as helium gas, nitrogen gas, argon gas, hydrogen gas, or air accommodated for example in a compressed state of approximately 0.2 to 10 MPa. Of course, the working gas G may be accommodated at atmospheric pressures.

The displacer cylinder 2c includes a cylindrical cylinder body 11 having openings at both ends thereof, and the openings are closed by circular end-face plates 12 and 13, respectively. In this case, bearing units 14 and 15 comprised of ball bearings or the like are fixed at the respective centers of the end-face plates 12 and 13. The bearing units 14 and 15 rotatably support a displacer shaft 17, which will be described later, and a rotating shaft of an electric motor 21, which will be described later, is coupled to a first end of the displacer shaft 17. For this reason, it is desirable that, as shown in FIG. 2, the end-face plates 12 and 13 cover the displacer shaft 17 and the electric motor 21 as well as the bearing units 14 and 15 so that all of them are located inside and be combined with the cylinder body 11 to bring the inside into a highly airtight hermetically sealed state. This makes it possible to prevent the working gas G from leaking out, thus making it possible to use, as the working gas G, any of the aforementioned low-molecular weight gases such as hydrogen gas or helium gas. Further, the cylinder body 11 is constituted by a combination of four panel members equally divided from one another in a circumferential direction. In this case, as shown in FIG. 1, the four panel members are two heat-insulating panels 13u and 13d located on the upper and lower sides, respectively, and two heat-transfer panels 13p and 13q located on the left and right sides, respectively. The heat-insulating panels 13u and 13d have high heat insulating properties, and the heat-transfer panels 13p and 13q have high thermal conductivity. Moreover, a working gas inlet/outlet 6 is provided in substantially the middle of the heat-insulating panel 13u located on the upper side. The working gas inlet/outlet 6 penetrates from the front side to the back side of the heat-insulating panel 13u. In this example, the number of working gas inlet/outlet is 1. Therefore, this embodiment can be carried out as the simplest embodiment.

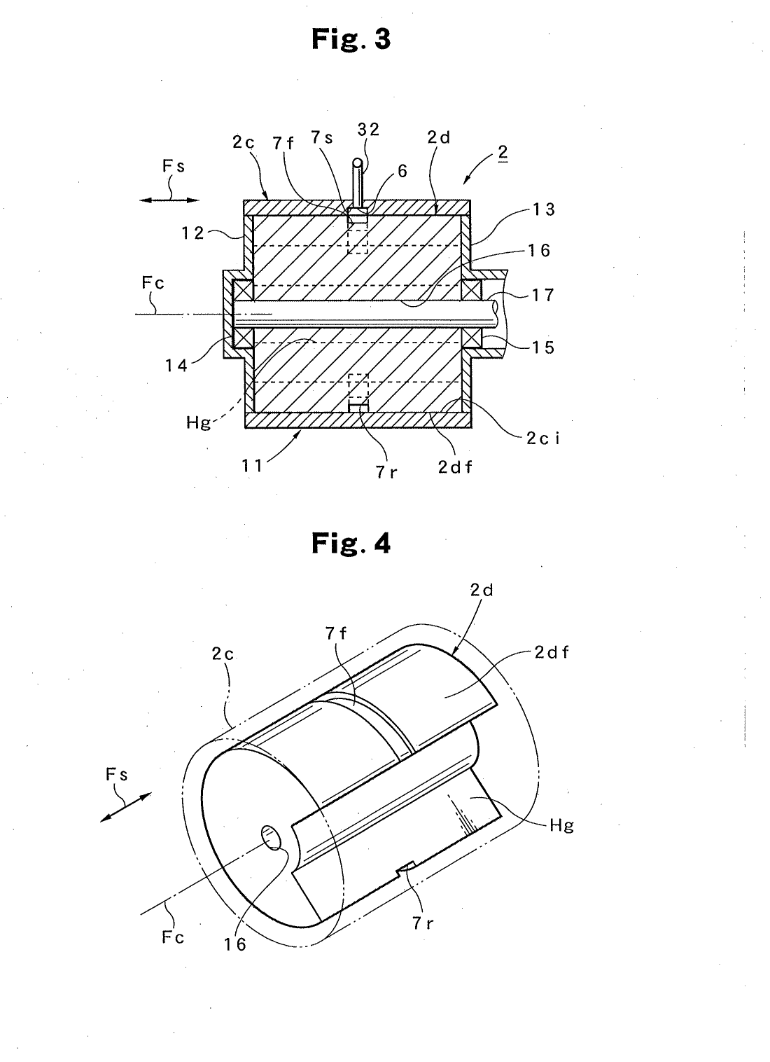

Meanwhile, as shown in FIG. 4, the displacer 2d has a circular cylindrical shape as a whole or, specifically, such a precisely circular cylindrical shape as to have an outer circumferential surface 2df that is parallel to an axial direction Fs with respect to a central axis Fc, and as shown in FIG. 3, the displacer 2d is fixed by inserting the displacer shaft 17 into a through-hole 16 provided on the central axis Fc. This causes both end sides of the displacer shaft 17 to project outward from both end faces of the displacer 2d and be rotatably supported by the bearing units 14 and 15, respectively, so that the displacer 2d serves a rotary displacer 2d whose central axis Fc rotates. Use of such a rotary displacer 2d allows the displacer body unit 2 to be most rationally and simply structured from a geometric standpoint. Therefore, this embodiment can be carried out as a most suitable embodiment in terms of building the Stirling engine 1 according to the present invention and achieve most suitable performance in terms of effectively ensuring the working effects of the present invention. Further, it is desirable that a heat-resistant and heat-insulating lightweight material be selected as a material of which the displacer 2d is made.

Moreover, the outer circumferential surface 2df of the displacer 2d and an inner circumferential surface 2ci of the displacer cylinder 2c are formed into such shapes as to be able to permit the rotation (movement) of the displacer 2d and inhibit passage of the working gas G. This leaves almost no gap between the outer circumferential surface 2df of the displacer 2d and the inner circumferential surface 2ci of the displacer cylinder 2c. Furthermore, as shown in FIG. 4, the displacer 2d has a gas retention space Hg which is formed on its outer circumferential surface 2df and having a shape obtained by cutting out a part of the outer circumferential surface 2df of the displacer 2d. As shown in FIG. 1, the gas retention space Hg thus exemplified is in the shape of a fan spread at substantially 90 degrees when viewed from the front, and is formed into a shape obtained by wholly cutting out along cutting lines parallel to the axial direction Fs. With this, rotation of the displacer 2d enables the working gas G in the gas retention space Hg to alternately move between a heating unit 3h side and a cooling unit 3c side of the displacer cylinder 2c.

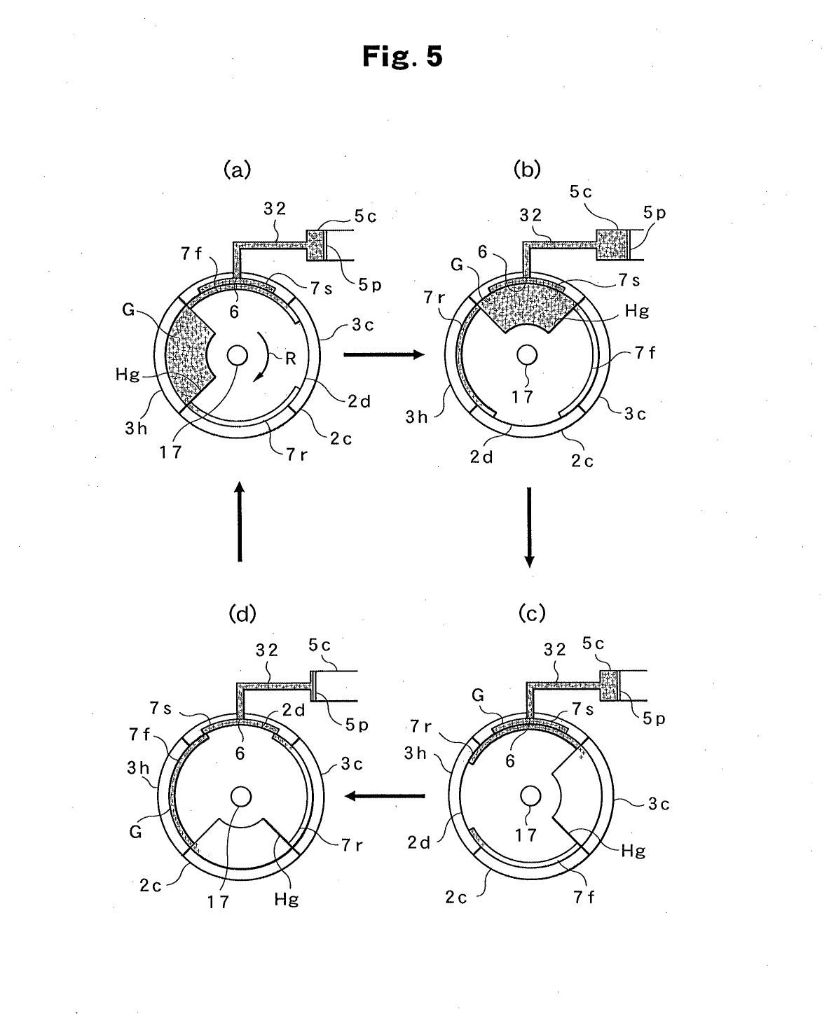

It should be noted that in a case where, as shown in the present embodiment, the cylinder body 11 is divided into four equal parts in a circumferential direction, the heat-transfer panels 13p and 13q are disposed respectively on the left and right sites to use for the heating unit 3h and the cooling unit 3c, the heat-insulating panels 13u and 13d are disposed respectively on the upper and lower sites, and the circumferential angle of the gas retention space Hg occupying inside the displacer 2d is set to be 90 degrees, the working gas G retained in the gas retention space Hg alternately moves between the heating unit 3h side and the cooling unit 3c side of the displacer cylinder 2c as the displacer 2d rotates, and does not simultaneously make contact with both regions on the heating unit 3h side and the cooling unit 3c side (see FIG. 5). This enables minimization of heat leak from the heating unit 3h side to the cooling unit 3c side through the working gas G, thus making it possible to contribute to an increase in energy conversion efficiency.

Further, the displacer 2d has a gas passageway 7 which is formed on its outer circumferential surface 2df and includes a gas passage groove that allows the gas retention space Hg to communicate with the working gas inlet and outlet 6 provided in the displacer cylinder 2c. The gas passageway 7 is constituted by a front passageway 7f and a rear passageway 7r formed in the middle of the displacer 2d in the axial direction Fs along a circumferential direction Ff. The front passageway 7f extends from a first end side of the gas retention space Hg in the circumferential direction Ff, and the rear passageway 7r extends from a second end side of the gas retention space Hg in the circumferential direction Ff. Moreover, as shown in FIG. 1, the front passageway 7f and the rear passageway 7r are formed as discontinuous passageways that are independent of each other. When the front passageway 7f and the rear passageway 7r are thus formed as discontinuous passageways that are independent of each other, the front passageway 7f and the rear passageway 7r, which are independent, bring the flow of the working gas G between the heating unit 3h and the cooling unit 3c into a blocked state, thus making it possible to surely prevent a heat leak through the gas passageway 7 even in a case where the gas passageway 7 is provided in the outer circumferential surface 2df of the displacer 2d. This enables the gas passageway 7 to communicate with the working gas inlet/outlet 6 provided in the displacer cylinder 2c. It should be noted that the working gas inlet/outlet 6 is connected to a power cylinder 5c, which will be described later.

Incidentally, in such a configuration, a part of the outer circumferential surface 2df of the displacer 2d that does not form the gas passageway 7 is present between the front passageway 7f and the rear passageway 7r, which are independent, to form an angle of rotation by which the inside of the displacer cylinder 2c is blocked from the working gas inlet/outlet 6. For this reason, the heat-insulating panel 13u (displacer cylinder 2c) has an auxiliary gas passageway 7s which is formed on a part of the inner circumferential surface 2ci that faces the working gas inlet/outlet 6 and includes a gas passage groove across a predetermined range of angles in the circumferential direction Ff. This causes the auxiliary gas passageway 7s to bridge between the front passageway 7f and the rear passageway 7r, allowing the working gas inlet/outlet 6 and the gas retention space Hg to communicate with each other without being blocked, regardless of the angle of rotation of the displacer 2d (see FIG. 5(d)). Provision of such an auxiliary gas passageway 7s makes it possible to ensure various passageways through a combination of the auxiliary gas passageway 7s and the gas passageway 7, thus giving the advantage of increasing the degree of freedom in design, including the choice in volume of the gas retention space Hg and heat-insulating structure.

The cooling and heating working unit 3 is constituted by the heating unit 3h and the cooling unit 3c. The heating unit 3h is constituted by attaching a predetermined heating source 3hm to the outer surface of the heat-transfer panel 13p disposed on a first side of the displacer cylinder 2c. The heating source 3hm needs only have a function of directly or indirectly heating the heat-transfer panel 13, and utilizable examples of the heating source 3h include various types of heating means such as a combustion apparatus using biomass fuel (quantitative biological resources), a heat collector that achieves high temperatures by collecting solar heat, and a heating apparatus that recycles waste energy such as factory exhaust heat (industrial waste heat). Therefore, the specific heating principle of the heating source 3hm may be any principle. Further, the cooling unit 3c is constituted by attaching a predetermined cooling source 3cm to an outer surface of the heat-transfer panel 13q disposed on a second side of the displacer cylinder 2c. The cooling source 3cm needs only have a function of directly or indirectly cooling the heat-transfer panel 13q, and utilizable examples of the cooling source 3cm include various types of cooling means such as a cooling water supplying apparatus that performs cooling by supplying cooling water to a water jacket attached to the outer surface of the heat-transfer panel 13q. Therefore, the specific cooling principle of the cooling source 3cm may be any principle. It should be noted that the cooling water is a concept that encompasses various types of liquid such as well water, river water, and tap water. In this case, the cooling water does not mean actively cooled water, but means water that is used to cool the heat-transfer panel 13q. For example, the cooling water may be in the form of direct use of waste water from a factory or the like.

On one hand, the displacer-driving actuator 4 has a function of rotating (moving) the displacer 2d, and the embodiment exemplifies the electric motor 21. The electric motor 21 also serves as a starter motor. The electric motor 21 has its rotation output shaft coupled to an end of the displacer shaft 17 directly or via a necessary decelerating mechanism or the like.

On the other hand, the power output unit 5 includes the power cylinder 5c, which contains a power piston 5p which is moved by the effect of volume change of the working gas G in the displacer cylinder 2c. In this case, as shown in FIG. 1, the power cylinder 5c has a first end closed by an end plate unit 31 and a second end opened. Moreover, a through-hole 31s provided in the end plate unit 31 and the working gas inlet/outlet 6 are connected via a connecting tube 32 so that the inside of the displacer cylinder 2c communicates with the inside of the power cylinder 5c via the gas passageway 7, the working gas inlet/outlet 6, and the connecting tube 32 and the airtightness to the outside is ensured. This makes it possible to convert the change in the volume of the working gas G into a mechanical displacement and take it out as a mechanical output. In the present embodiment, a generator 33 is added so that an electrical output can be taken out from the generator 33. Hence, a rotation input shaft 33s of the generator 33 and an outer end face of the power piston 5p are connected via a crack mechanism 34. This converts a forward and backward motion of the power piston 5p into a rotational motion via the crank mechanism 34, and the rotational motion is imparted to the rotation input shaft 33s. Thus, the electrical output from the generator 33 becomes available for taking out as an output of the Stirling engine 1 according to the present embodiment. Further, a part of this electrical output is supplied to the electric motor 21 to be utilized in driving the electric motor 21.

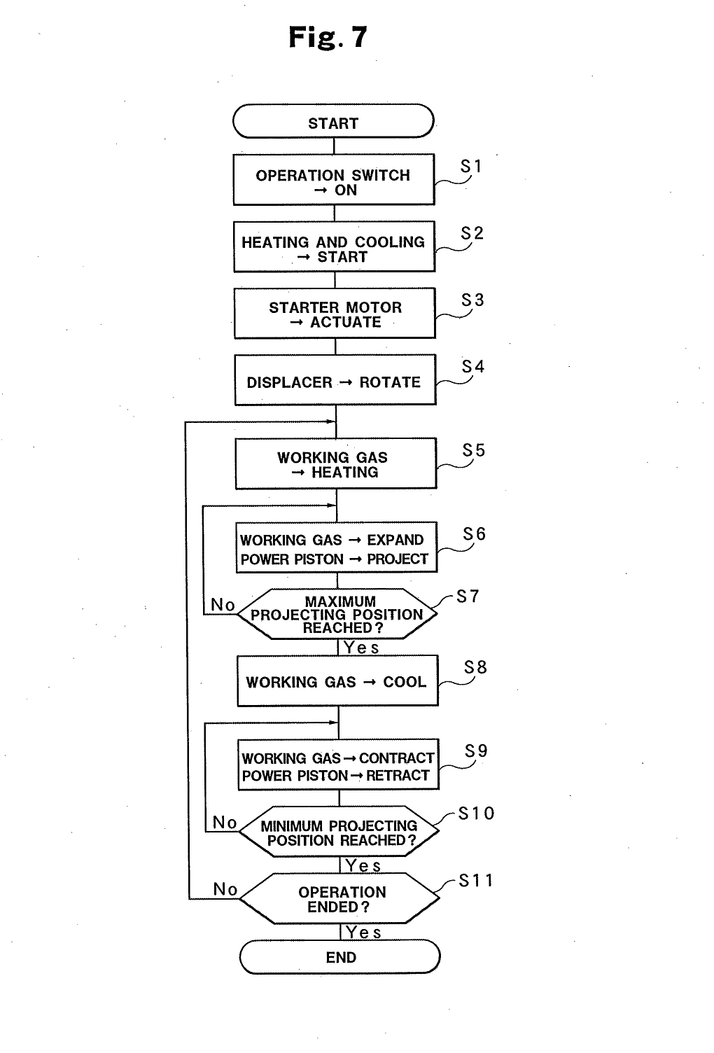

Next, operation of the Stirling engine 1 according to the present embodiment (basic embodiment) is described with reference to FIGS. 5 and 7.

It should be noted that FIG. 5(a) to (d) show an explanatory diagram of steps of operation of the Stirling engine 1, and FIG. 7 shows a flow chart which explains the operation of the Stirling engine 1. First, an operation switch (not illustrated) is turned on (step S1). This brings the heating unit 3h and the cooling unit 3c into an operating state so that the heat-transfer panel 13p is heated and the other heat-transfer panel 13q is cooled (step S2). In so doing, the heating-side heat-transfer panel 13p is normally heated by the heating source 3hm to several hundred degrees Celsius, and the cooling-side heat-transfer panel 13q is cooled by the cooling source 3cm (such as cooling water). Once the heating temperature and the cooling temperature reach target temperatures and become stable, a start switch is turned on. This causes the electric motor 21, which also serves as a starter motor, to rotate so that the displacer 2d rotates in the direction of the arrow R in FIG. 5(a) (steps S3 and S4).

Let it be assumed here that before starting to rotate, the displacer 2d is in a position (angle of rotation) shown in FIG. 5(a), i.e. a position where the gas retention space Hg of the displacer 2d faces leftward and the whole of the gas retention space Hg faces substantially the whole surface of the heating-side heat-transfer panel 13p. In this position, the working gas G in the gas retention space Hg is heated by the heating unit 3h (step S5). In particular, the working gas G becomes most heated in this position. Therefore, the working gas G expands, and a portion of the working gas G which increased in volume due to this expansion acts on the power cylinder 5c via the front passageway 7f, the auxiliary gas passageway 7s, and the connecting tube 32, so that the power piston 5p moves in such a direction as to project (step S6). In the case of the Stirling engine 1 according to the present embodiment, the whole quantity of the working gas G in the gas retention space Hg moves between the heating unit 3h side and the cooling unit 3c side as the displacer 2d rotates, and only the portion of the working gas G which changed by the expansion (and the contraction) of the working gas G moves through the gas passageway 7, the auxiliary gas passageway 7s, and the connecting tube 32. For this reason, a loss of pressure (loss of energy) and a loss of heat during passage through the gas passageway 7 and the connecting tube 32 are much smaller than in the case of a linear displacer in which the whole quantity of the working gas in the expansion space and the compression space moves through a gas passageway and the like as the displacer 2d reciprocates.

Meanwhile, when the displacer 2d rotates in the direction of the arrow R in the drawing and reaches a position shown in FIG. 5(b) where the gas retention space Hg faces upward, i.e. when the gas retention space Hg reaches substantially the middle position between the heating unit 3h and the cooling unit 3c, substantially the maximum volume of the working gas G acts on the power cylinder 5c, so that the power piston 5p reaches a maximum projecting position (bottom dead center) (step S7). Further, at this point in time (position), where the gas retention space Hg reaches substantially the middle position between the heating unit 3h and the cooling unit 3c, the whole of the working gas G switches from being heated to being cooled, so that the working gas G starts to be cooled by the cooling unit 3c (step S8).

Then, when the displacer 2d further rotates, the working gas G contracts due to cooling, and a portion of the working gas G which decreased in volume due to this contraction acts on the power cylinder 5c via the rear passageway 7r, the auxiliary gas passageway 7s, and the connecting tube 32, so that the power piston 5p moves in such a direction as to retract (step S9). After this, when the displacer 2d reaches a position shown in FIG. 5(c) where the gas retention space Hg faces rightward, i.e. a position where the whole of the gas retention space Hg faces substantially the whole surface of the other heat-transfer panel 13q, the working gas G in the gas retention space Hg becomes most cooled by the cooling unit 3c. This causes the working gas G to further contract, and a portion of the working gas G which decreased in volume due to this contraction acts on the power cylinder 5c via the rear passageway 7r, the auxiliary gas passageway 7s, and the connecting tube 32, so that the power piston 5p continues to move in such a direction as to retract. After this, when the displacer 2d further rotates and reaches a position shown in FIG. 5(d) where the gas retention space Hg faces downward, i.e. when the gas retention space Hg reaches substantially a middle position between the cooling unit 3c and the heating unit 3h, substantially the minimum volume of the working gas G acts on the power cylinder 5c, so that the power piston 5p reaches a minimum projecting position (top dead center) (step S10). Further, at this point in time (position), where the gas retention space Hg reaches substantially the middle position between the cooling unit 3c and the heating unit 3h, the whole of the working gas G switches from being cooled to being heated, so that the working gas G starts to be heated by the heating unit 3h (step S11, S5). After this, when the displacer 2d further rotates, the working gas G expands due to heating, and a portion of the working gas G which increased in volume due to this expansion acts on the power cylinder 5c via the front passageway 7f, the auxiliary gas passageway 7s, and the connecting tube 32, so that the power piston 5p moves in such a direction as to project (step S6). Then, when the displacer 2d further rotates, the displacer 2d reaches the initial position (angle of rotation) shown in FIG. 5(a).

The foregoing is one cycle of the Stirling engine 1 in which the displacer 2d makes one rotation, and the same operation is repeatedly and continuously performed unless the operation is stopped, for example, by turning off the operation switch (steps S11, S5 . . . ). Further, the continued rotation of the displacer 2d causes the power piston 5p to repetitively move between the bottom dead center and the top dead center. As a result, this repetitive movement is transmitted to the generator 33 via the crank mechanism 34, and the generator 33 generates and outputs electricity. That is, a repetitive motion of the power piston 5p generated by the rotation of the displacer 2d is converted into a rotational motion by the crank mechanism 34 to rotate the rotation input shaft 33s of the generator 33. Then, the output from the generator 33 is taken out as an energy output of the Stirling engine 1, and a part of the output is supplied to the electric motor 21 to be used as energy to rotate the displacer 2d.

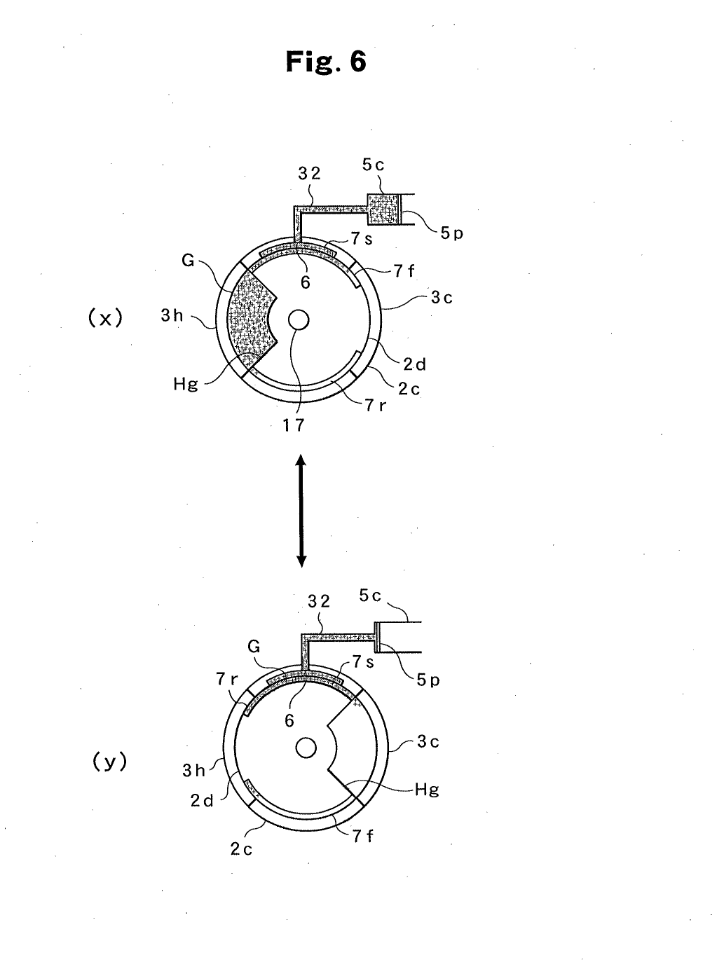

Incidentally, while the foregoing operation serves as a method of use for performing a continuous operation (constant-speed control) in which the displacer 2d continuously rotates, the Stirling engine 1 according to the present embodiment is also applicable to a method of use for performing an intermittent operation (rectangular wave control) in which the displacer 2d intermittently rotates. This method of use for performing an intermittent operation is described with reference to an explanatory diagram of steps of operation shown in FIGS. 6(x) and (y).

In the intermittent operation, the displacer 2d can be intermittently, rotated by 180 degrees at a time by supplying a rectangular wave driving signal to the electric motor 21 that rotates the displacer 2d. Let it be assumed here that the displacer 2d is in a heating position shown in FIG. 6(x). In the heating position, the gas retention space Hg of the displacer 2d faces leftward, and the whole of the gas retention space Hg faces the heating unit 3h. Moreover, in this heating position, the rotation of the displacer 2d is suspended for a predetermined period of time. As this predetermined period of time, a period of time during which the working gas G is heated and the power piston 5p reaches a bottom dead center position shown in FIG. 6(x) can be selected.

Meanwhile, when the rotation is suspended for the predetermined period of time and the power piston 5p reaches the bottom dead center position, the electric motor 21 is actuated. This causes the displacer 2d to make a quick rotational movement to a cooling position shown in FIG. 6(y). In the cooling position, the gas retention space Hg of the displacer 2d faces rightward, and the whole of the gas retention space Hg faces the cooling unit 3c. Then, once the displacer 2d reaches this cooling position, the rotation is suspended for a predetermined period of time. As this predetermined period of time, a period of time during which the working gas G is cooled and the power piston 5p reaches a top dead center position shown in FIG. 6(y) can be selected. Further, when the rotation is suspended for the predetermined period of time and the power piston 5p reaches the top dead center position, the electric motor 21 is actuated. This causes the displacer 2d to make a quick rotational movement to the heating position shown in FIG. 6(x). In the intermittent operation, the foregoing operation is repeatedly and continuously performed.

Thus, in the Stirling engine 1 according to the present embodiment, the structure of the displacer body unit 2 only needs two basic components, namely the displacer 2d . . . and the displacer cylinder 2c . . . and does not need means such as building a sectioned structure with an additional component. Therefore, in particular, even a Stirling engine 1 using a rotary displacer 2d . . . allows the working gas G heated by the heating unit 3h to efficiently act on the power cylinder 5c and, what is more, can contribute to a reduction in cost by reducing the number of components and simplifying the structure, and by extension to a reduction in size and weight. Moreover, the absence of a movable mechanism unit that is added to the displacer 2d . . . makes it possible to easily ensure durability and reliability.

Further, the gas retention space Hg, which enables the working gas G to be alternately moved between the heating unit 3h side and the cooling unit 3c side of the displacer cylinder 2c . . . by the movement of the displacer 2d . . . , is formed on a part of the outer circumference of the displacer 2d . . . , and the outer circumferential surface 2df of the displacer 2d . . . and the inner circumferential surface 2ci of the displacer cylinder 2c . . . are formed into such shapes as to be able to permit movement of the displacer 2d . . . and inhibit passage of the working gas G. Such an airtight structure makes it possible to effectively inhibit a leak (heat leak) of the working gas G between the heating unit 3h and the cooling unit 3c, thus making it possible to reduce unnecessary loss of energy and increase energy conversion efficiency in the Stirling engine 1 from the structural aspect of the displacer body unit 2.

In particular, in the case of the Stirling engine 1 according to the present embodiment, the energy needed to rotate (move) the displacer 2d is merely equivalent to the sum of the energy lost by friction between the surface of the displacer 2d and the working gas G and the energy lost by the frictional resistance of the bearing units 14 and 15 of the displacer shaft 17. Since these losses of energy are very small, the Stirling engine 1 according to the present embodiment can be used even in a case where the heating unit 3h is at a comparatively low temperature or a case where the temperature difference between the heating unit 3h and the cooling unit 3c is comparatively small, thus making it possible to utilize various heat sources including natural energy such as solar heat and biomass and, furthermore, waste energy such as factory exhaust heat.

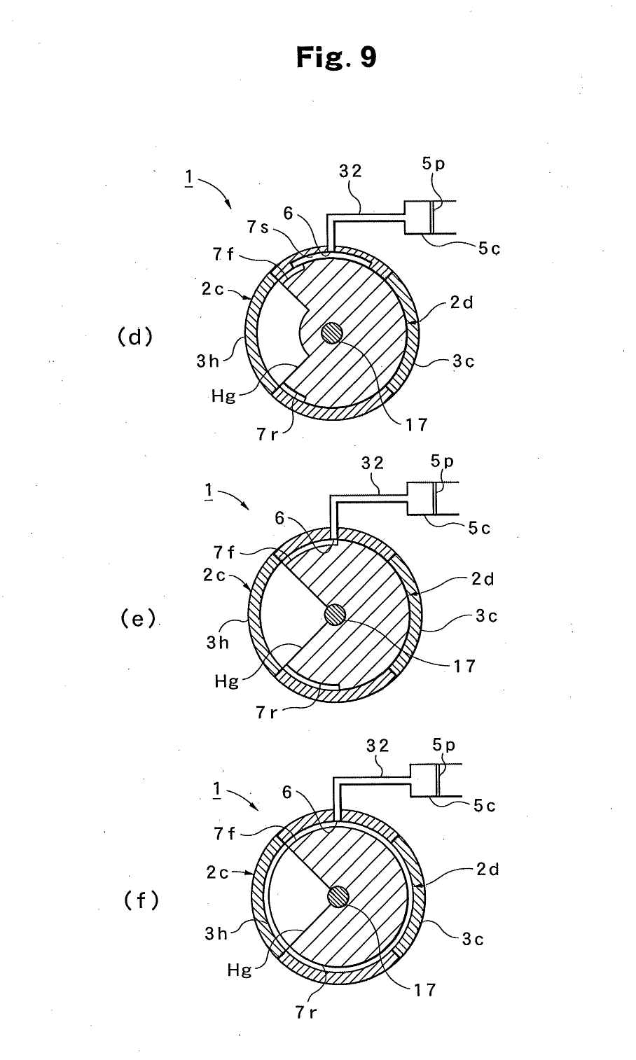

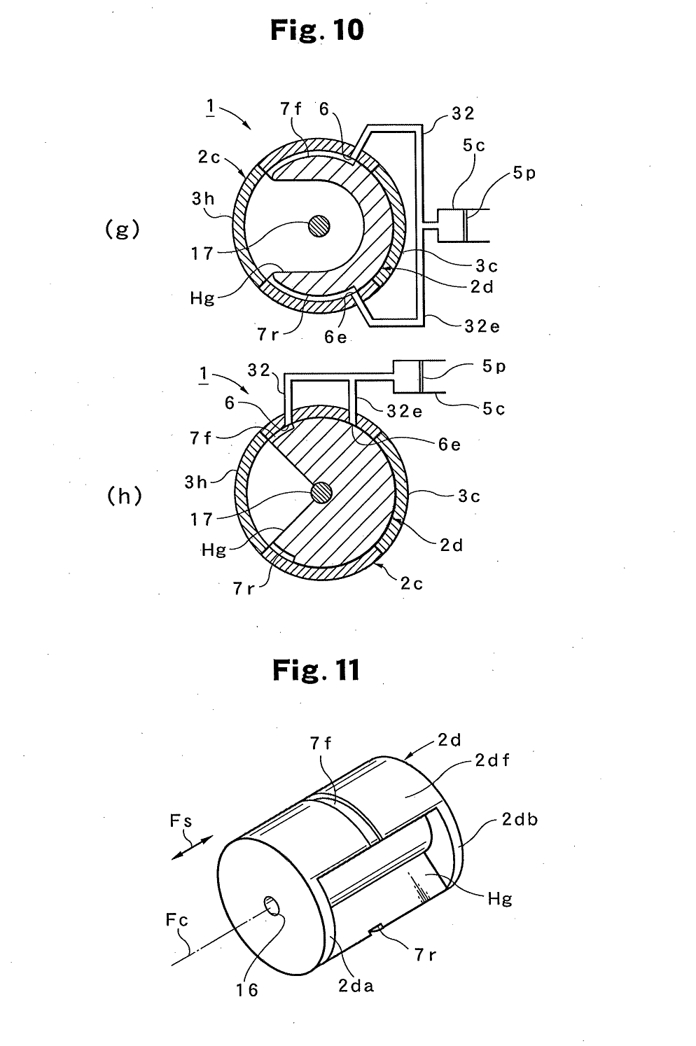

In addition, as mentioned above, the Stirling engine 1 according to the present embodiment is capable of intermittent operation (rectangular wave control) as well as continuous operation (constant-speed control). In a case where the intermittent operation (rectangular wave control) is performed, the gas retention space Hg formed on a part of the outer circumference of the displacer 2d nearly instantaneously moves between the heating unit 3h side and the cooling unit 3c side of the displacer cylinder 2c; therefore, the working gas G in the gas retention space Hg is almost always in either a heated state or a cooled state, and the working gas G takes substantially twice as long to be heated and to be cooled in comparison to the case of continuous operation. For this reason, the heating unit 3h and the cooling unit 3c transmit substantially twice as large amounts of heating and cooling and engine output to the working gas G as in the case of continuous operation. Moreover, this configuration gives the advantages of making it possible to shorten the length of the vent pipe and simplify the structures of the displacer 2d and the displacer cylinder 2c (FIGS. 9(d), (e), FIG. 10(h)). On the other hand, this configuration gives negative implications such as a loss of kinetic energy by repetitive rotation and stoppage of the electric motor 21 and the displacer 2d and a loss of electric energy and a reduction in durability in the electric motor 21 by repetitive rotation and stoppage. Further, this configuration makes it necessary to attach means for detecting the position of the power piston 5p and makes a drive control apparatus more complicated than in the case of continuous operation. Therefore, which operation method to employ can be selected according to the intended use or application.

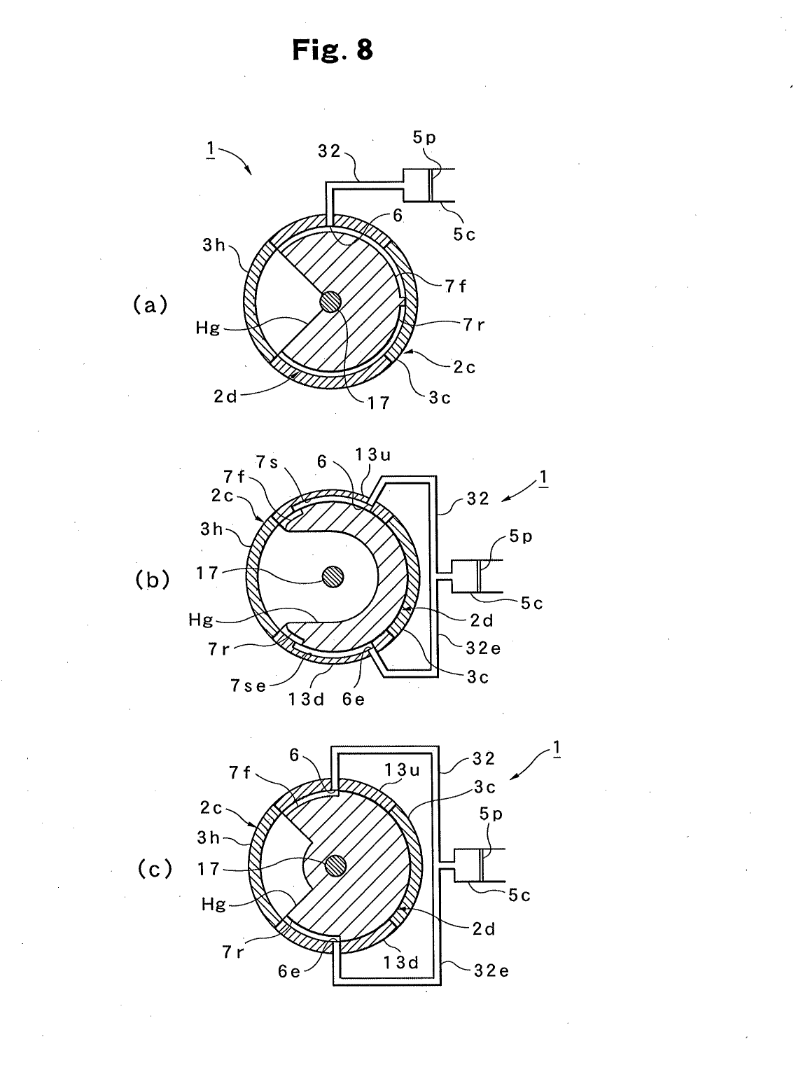

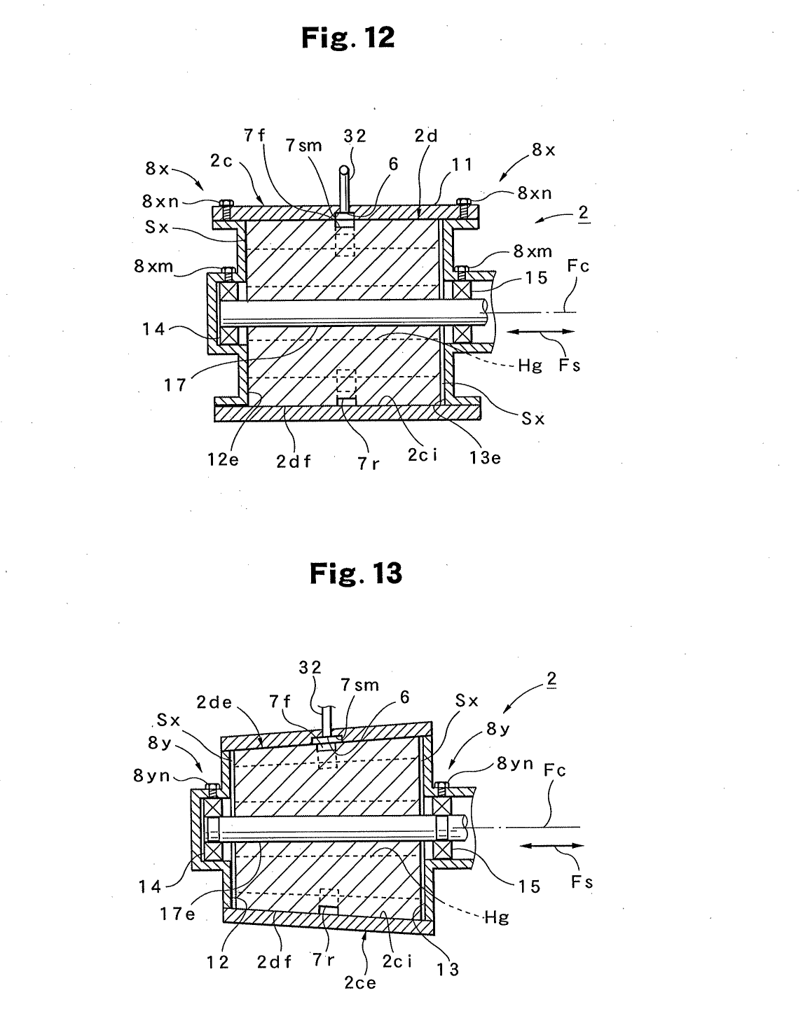

Next, various types of Stirling engine 1 . . . according to modified embodiments of the present invention are described with reference to FIGS. 8 to 20. It should be noted that FIGS. 8(a) to 11 show examples where the displacer body unit 2 are in different geometric forms, that FIGS. 12 to 19 show examples where additional functions are added, and that FIG. 20 shows an example where a linear displacer 2ds is used.

The modified embodiment shown in FIG. 8(a) differs from the embodiment (basic embodiment) shown in FIG. 1 in that no auxiliary gas passageway 7s is provided, that the front passageway 7f and the rear passageway 7r are discontinuously formed but with as small as possible a width of division therebetween or, desirably, with a width equal to (or narrower than) the width of opening of the working gas inlet/outlet 6, and that the radial width of the gas retention space Hg is selected to be approximately equal to the radius. Except for these points, the modified embodiment shown in FIG. 8(a) is identical in configuration and operation to the basic embodiment shown in FIG. 1. This modified embodiment shows that the auxiliary gas passageway 7s is not always needed, and gives the advantages of simplifying the structure of the displacer cylinder 2c and making it possible to make the volume of the gas retention space Hg larger than in the basic embodiment shown in FIG. 1.

The modified embodiment shown in FIG. 8(b) differs from the basic embodiment shown in FIG. 1 in that two working gas inlet/outlets 6 and 6e are provided, that two auxiliary gas passageways 7s and 7se communicating with the respective working gas inlet/outlets 6 . . . are provided, and that the volume of the gas retention space Hg is made even larger than in the embodiment of FIG. 8(a) by forming the cross-section of the gas retention space Hg into a U shape striding over the displacer shaft 17. Specifically, the first and second working gas inlet/outlets 6 and 6e are provided in the upper and lower heat-insulating panels 13u and 13d, respectively, and the working gas inlet/outlets 6 and 6e are convergently connected to the power cylinder 5c via connecting tubes 32 and 32e, respectively. The provision of the two working gas inlet/outlets 6 and 6e allows this modified embodiment to shorten the lengths of the front and rear passageways 7f and 7r and connect the gas retention space Hg to the power cylinder 5c via one or both of the working gas inlet/outlets 6 and 6e regardless of the angle of rotation of the displacer 2d. In particular, the optimization of input and output positions according to various types of embodiment is enabled for a higher degree of freedom in design, and various embodiments can be build, including the choice in volume of the gas retention space Hg and heat-insulating structure, by changing the aspects of the working gas inlet/outlets 6 . . . . It should be noted that in a case where the volume of the gas retention space Hg is comparatively large as in this modified embodiment, the Stirling engine 1 is suitable for specifications under which the temperature of the heating unit 3h is low and the speed of rotation of the displacer 2d is low. On the other hand, in a case where the volume of the gas retention space Hg is comparatively small, the Stirling engine 1 is suitable for specifications under which the temperature of the heating unit 3h is high and the speed of rotation of the displacer 2d is high.

The modified embodiment shown in FIG. 8(c) is identical in basic configuration to that shown in FIG. 8(b), but differs from that shown in FIG. 8(b) in terms of the positions where the two working gas inlet/outlets 6 and 6e are provided and, furthermore, the lengths of the front and rear passageways 7f and 7r. In the embodiment of FIG. 8(c), the two working gas inlet/outlets 6 and 6e are provided in the middles of the heat-insulating panels 13u and 13d, respectively, in a circumferential direction. Meanwhile, in the embodiment of FIG. 8(b), the two working gas inlet/outlets 6 and 6e are provided closer to the cooling unit 3c. Thus, the positions where the working gas inlet/outlets 6 and 6e are provided can be selected freely. Further, in the embodiment of FIG. 8(c), no auxiliary gas passageways 7s and 7se are needed, as the front passageway 7f and the rear passageway 7r are set to be sufficiently longer than in the embodiment of FIG. 8(b).

The modified embodiment shown in FIG. 9(d) differs from the basic embodiment shown in FIG. 1 in that the front passageway 7f and the rear passageway 7r are shorter in length. In this modified embodiment, the front passageway 7f and the rear passageway 7r are shorter in length, and there is a range of angles of rotation of the displacer 2d across which the gas retention space Hg and the working gas inlet/outlet 6 (power cylinder 5c) are blocked from each other. In the case thus exemplified, the gas retention space Hg and the working gas inlet/outlet 6 are blocked from each other across a range of angles of rotation of approximately 180 degrees. Therefore, the embodiment of FIG. 9(d), in which the front passageway 7f and the rear passageway 7r are short, can improve the performance of heat insulation between the heating unit 3h side and the cooling unit 3c side of the outer circumferential surface 2df of the displacer 2d, but is unsuitable for continuous rotational operation. As such, the embodiment of FIG. 9(d) is suitable for the aforementioned method of use in which the displacer 2d is intermittently rotated. Meanwhile, the modified embodiment shown in FIG. 9(e) is identical in basic configuration to that shown in FIG. 9(d), but shows an example where no auxiliary gas passageway 7s is provided, where the front passageway 7f and the rear passageway 7r are long, and where the shape of the gas retention space Hg is the same as that in the embodiment of FIG. 8(a). In the embodiment of FIG. 9(e), as in that of FIG. 9(d), there is a range of angles of rotation of the displacer 2d across which the gas retention space Hg and the working gas inlet/outlet 6 are blocked from each other. As such, the embodiment of FIG. 9(a) is suitable for the case where intermittent operation is performed.

The modified embodiment shown in FIG. 9(f) differs from the modified embodiments shown in FIGS. 8 and 9(e) in that the front passageway 7f and the rear passageway 7r are continuously formed. That is, in forming the gas passageway 7, the front passageway 7f, which extends from the first end side of the gas retention space Hg in the circumferential direction Ff along the circumferential direction Ff of the displacer 2d, and the rear passageway 7f, which extends from the second end side of the gas retention space Hg in the circumferential direction Ff along the circumferential direction Ff of the displacer 2d, are provided, and the front passageway 7f and the rear passageway 7r are formed as continuous passageways that communicate with each other. Forming the front and rear passageways 7f and 7r as such continuous passageways generates a small amount of heat leak through the gas passageway 7, but eliminates the switching between the front passageway 7f and the rear passageway 7r to the working gas inlet/outlet 6, thus making it possible to ensure the continuity and stability of the working gas G flowing between the gas passageway 7 and the working gas inlet/outlet 6. This makes it possible to build various embodiments by selecting discontinuous passageways or continuous passageways according to the status of the heat source, the intended use, and the like.

The modified embodiment shown in FIG. 10(g) is identical in basic configuration to that shown in FIG. 8(b), but differs from it in that auxiliary gas passageways 7s and 7se are not provided. However, except for this point, the modified embodiment shown in FIG. 10(g) is identical in basic configuration to that shown in FIG. 8(b) and can therefore perform the same operation. Meanwhile, the modified embodiment shown in FIG. 10(h) is identical in basic configuration to that shown in FIG. 9(e), but differs from it in that two working gas inlet/outlets 6 and 6e are provided at a distance from each other on the upper heat-insulating panel 13u and that the front passageway 7f and the rear passageway 7r are shorter in length. In this modified embodiment, there is a range of angles of rotation of the displacer 2d across which the gas retention space Hg and the working gas inlet/outlet 6 (power cylinder 5c) are blocked from each other. Therefore, this modified embodiment can improve the performance of heat insulation between the heating unit 3h side and the cooling unit 3c side of the outer circumferential surface 2df of the displacer 2d, but is unsuitable for continuous rotational operation. As such, this modified embodiment is suitable for the aforementioned method of use in which the displacer 2d is intermittently rotated.

On the other hand, the modified embodiment shown in FIG. 11 is one obtained by changing the method of forming the gas retention space Hg in the displacer 2d. In the basic embodiment shown in FIG. 1, as shown in FIG. 4, the gas retention space Hg is formed by completely notching a part of the displacer 2d between first and second end faces of the displacer 2d. Meanwhile, certain parts of the displacer 2d according to the embodiment of FIG. 11, which are on both the first and second end-face sides of the displacer 2d, are not notched but left as barrier parts 2da and 2db of predetermined width in the axial direction Fs. That is, while the gas retention space Hg of the embodiment shown in FIG. 1 is a space opened in the axial direction, the gas retention space Hg of the embodiment shown in FIG. 11 is a space closed in the axial direction. This makes the volume of the gas retention space Hg smaller in the embodiment shown in FIG. 11, but is advantageous in that the barrier parts 2da and 2db inhibit the working gas G retained in the gas retention space Hg from leaking toward the end faces.

The modified embodiment shown in FIG. 12 is one in which, in configuring the displacer cylinder 2c, adjustment end-face plates 12e and 13e are configured by changing the shapes of the pair of end-face plates 12 and 13, which close the openings at both ends of the cylinder body 11. In particular, the modified embodiment shown in FIG. 12 is one in which the adjustment end-face plates 12e and 13e are configured to be relatively displaceable in the axial direction Fs with respect to the cylinder body 11 and the bearing units 14 and 15, respectively, which support the displacer shaft 17, in which the adjustment end-face plates 12e and 13e are fixable to the cylinder body 11 by fixing screws 8xn, 8xn . . . , and in which the adjustment end-face plates 12e and 13e are fixable to the bearing units 14 and 15 by fixing screws 8xm, 8xm. . . .

This makes it possible to configure clearance adjustment mechanisms 8x, 8x that are capable of adjusting clearances Sx . . . between both end faces of the displacer 2d and the inner surfaces of the ends of the displacer cylinder 2c. In this case, in making a clearance adjustment on an adjustment end-face plate 12e side, the clearance Sx between the first end face of the displacer 2d and the inner surface of the adjustment end-face plate 12e can be adjusted by loosening the fixing screws 8xn . . . and 8xm . . . and displacing the adjustment end-face plate 12e in the axial direction Fs. Further, after the adjustment, the fixing screws 8xn . . . and 8xm . . . need only be tightened for fixation. Furthermore, a clearance adjustment on an adjustment end-face plate 13e side can be made in the same manner as an adjustment end-face plate 12e side. It should be noted that, in FIG. 12, the adjustment end-face plate 12e is in a state where the clearance Sx has been adjusted to be substantially 0, and the adjustment end-face plate 13e is in a state where the clearance Sx is comparatively large, i.e. a pre-adjustment state. Provision of such clearance adjustment mechanisms 8x . . . makes it possible to adjust the clearances Sx . . . between both end faces of the displacer 2d and the inner surface of the ends of the displacer cylinder 2c (inner surfaces of the adjustment end-face plates 12e and 13e) to the minimum levels, thus giving the advantages of making it possible to easily optimize the clearances Sx . . . and contribute to further improvement in performance.

The modified embodiment shown in FIG. 13 is one in which the displacer body unit 2 includes a rotary displacer 2de whose central axis Fc rotates and whose outer circumferential surface 2df is tapered, and in which the displacer body unit 2 includes position adjustment mechanisms 8y, 8y that are capable of adjusting the position of the rotary displacer 2de in the axial direction Fs with respect to a displacer cylinder 2ce. In this case, for example, as shown in FIG. 13, the position adjustment mechanisms 8y . . . can be configured by providing bearing units 14 and 15, which support a displacer shaft 17e, so that the bearing units 14 and 15 can be displaced in the axial direction Fs, and fixing the bearing units 14 and 15 with fixing bolts 8yn, 8yn . . . that can be loosened. Provision of such position adjustment mechanisms 8y . . . makes it possible to adjust the position of the displacer 2de in the axial direction Fs and adjust the gap (radial gap) between the outer circumferential surface of the displacer 2de and the displacer cylinder 2ce to the minimum level, thus making it possible to easily optimize the gap and contribute to further improvement in performance. It should be noted that since the displacer 2de is displaceable in the axial direction Fs, the auxiliary gas passage 7s (or the working gas inlet/outlet 6) is formed as an auxiliary gas passageway 7sm that becomes wider in the axial direction Fs. This allows the gas passageway 7 to surely communicate with the working gas inlet/outlet 6 regardless of the position of the displacer 2de in the axial direction Fs.

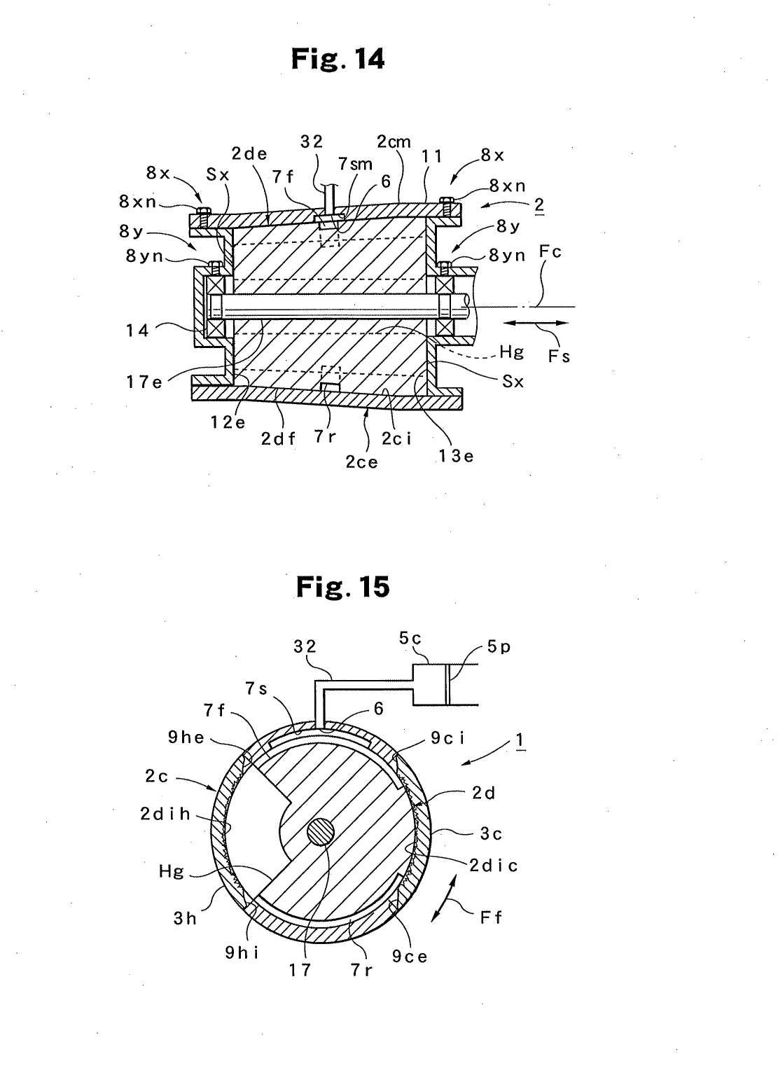

The modified embodiment shown in FIG. 14 is one obtained by adding the modified embodiment of FIG. 12 to the modified embodiment of FIG. 13. That is, since the modified embodiment of FIG. 13 is configured not to include the modified embodiment of FIG. 12, the clearances Sx . . . on the sides of the bearing units 14 and 15 are both comparatively large. On the other hand, in the modified embodiment of FIG. 14, parts that are parallel to the axial direction Fs, i.e. parts that are uniform in diameter over a predetermined width in the axial direction Fs, are provided on certain parts of both end sides of the cylinder body 11 in the axial direction Fs. These parts are identical in configuration to those of the modified embodiment of FIG. 12. Therefore, the fixing bolts 8yn . . . of the position adjustment mechanisms 8y . . . of FIG. 14 also serve as the fixing bolts 8xm . . . of the clearance adjustment mechanisms 8x . . . , so the embodiment includes both the clearance adjustment mechanisms 8x . . . and the position adjustment mechanisms 8y. . . .

In this case, a part that is parallel to the axial direction Fs, i.e. a part that is uniform in diameter over a predetermined width in the axial direction Fs, is provided on a part of the end on the side of the displacer 2d that is larger in diameter. Such a configuration makes it possible, without requiring precision work or fine adjustment, to prevent contact between the outer circumference surface 2df and the inner circumferential surface 2ci of the displacer cylinder 2ce at the end on the side of the displacer 2d that is larger in diameter, although the displacer body unit 2 becomes slightly complex in structure. Such a part of the end on the side of the displacer 2d which is larger in diameter does not necessarily need to be provided as a part that is uniform in diameter, and even an embodiment without such a part can be carried out.

It should be noted that FIG. 14 shows a state where the position of the displacer 2de in the axial direction Fs has been adjusted by the position adjustment mechanisms 8y . . . and the gap (radial gap) between the outer circumferential surface of the displacer 2de and the displacer cylinder 2ce has been adjusted to substantially 0 (minimum level), and shows a state where the clearances between both end faces of the displacer 2de and the inner surface of the ends of the displacer cylinder 2ce (inner surfaces of the adjustment end-face plates 12e and 13e) have been adjusted by the clearance adjustment mechanisms 8x . . . and the clearances Sx . . . between both end faces of the displacer 2de and the inner surfaces of the adjustment end-face plates 12e and 13e have been adjusted to substantially 0 (minimum levels).

The modified embodiment shown in FIG. 15 differs from the basic embodiment shown in FIG. 1 in that inner circumferential surfaces 2dih and 2dic of the displacer cylinder 2c which correspond to the heating unit 3h and the cooling unit 3c are formed by corrugated surfaces to enlarge the actual surface area, that a first and/or second end side(s) of the inner circumferential surface 2dih, which corresponds to the heating unit 3h of the displacer cylinder 2c, in the circumferential direction is/are notched to provide a small-capacity auxiliary space(s) 9hi and/or 9he in which the working gas G is always preliminarily heated, and that a first and/or second end side(s) of the inner circumferential surface 2dic, which corresponds to the cooling unit 3c of the displacer cylinder 2c, in the circumferential direction is/are notched to provide a small-capacity auxiliary space(s) 9ci and/or 9ce in which the working gas G is always preliminarily cooled. In this case, each of the auxiliary spaces 9hi, 9he, 9ci, and 9ce can be formed into oblique sliced shapes so that the notches become gradually deeper from the inner sides towards the outer edge sides in the circumferential direction Ff of the inner circumferential surfaces 2dih and 2dic. The provision of the inner circumferential surfaces 2dih and 2dic formed by corrugated surfaces to enlarge surface area makes it possible to increase the actual heat-transfer area between the heating and cooling units 3h and 3c and the working gas G, thus giving the advantage of enabling contribution to improvement in heat-exchange efficiency. Further, provision of the auxiliary spaces 9hi, 9he, 9ci, and 9ce enables enhancement of heating and cooling at the start and/or end of heating and the start and/or end of cooling, thus enabling contribution to improvement in heat-exchange efficiency.

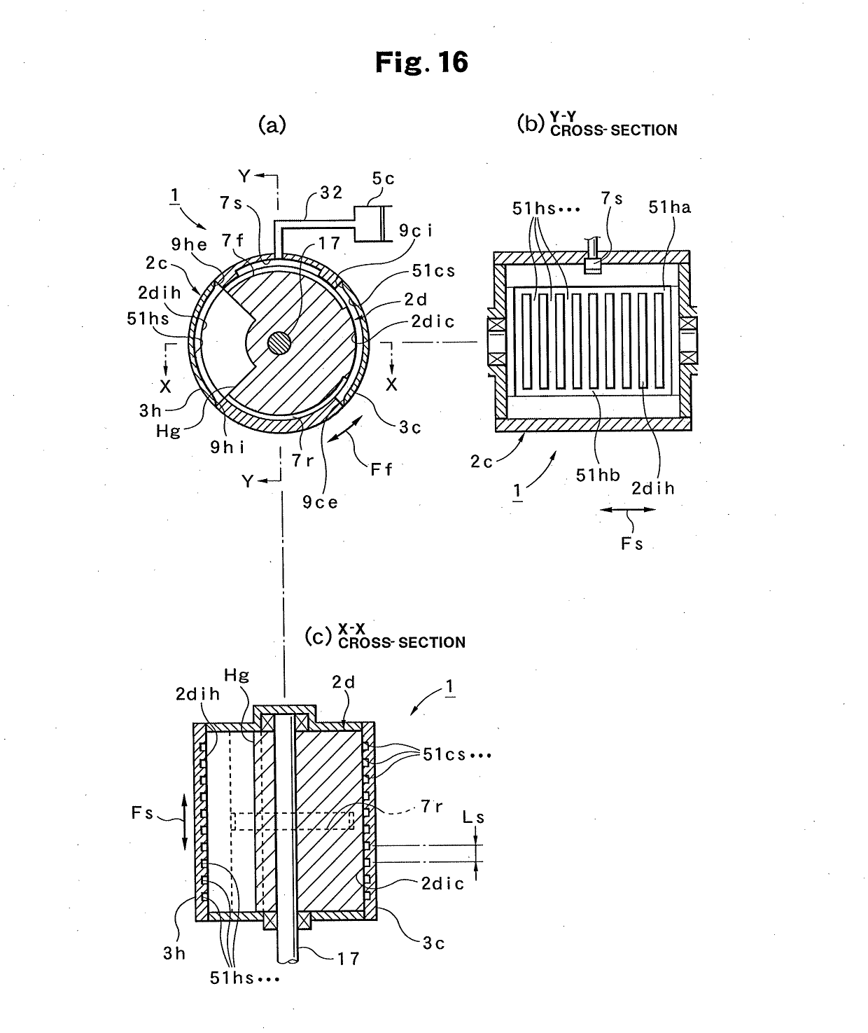

FIG. 16 shows a modification of the modified embodiment shown in FIG. 15. The corrugated surfaces, by which the inner circumferential surfaces 2dih and 2dic are formed, are formed by a plurality of depressed grooves 51hs . . . and 51cs . . . placed at predetermined intervals Ls . . . in the axial direction Fs as shown in FIG. 16(c) and extending along the circumferential direction Ff as shown in FIGS. 16(a) and (b). In the case thus exemplified, as shown in FIG. 16(c), the depressed grooves 51hs . . . on the heating unit 3h side have rectangular cross-sectional shapes, and at both ends of each of the depressed grooves 51hs . . . , common depressed grooves 51ha and 51hb, formed in an orthogonal direction to communicate the ends of each of the depressed grooves 51hs . . . with each other, are provided.

With this, at a point in time where a leading end side of the gas retention space Hg in a rotational direction (circumferential direction Ff) reaches the common depressed groove 51hb, the working gas G in the gas retention space Hg enters each of the depressed grooves 51hs . . . on the inner circumferential surfaces 2dih of the heating unit 3h. This makes it possible to advance the heating starting timing, in addition to increasing the actual surface area with the corrugated surfaces, thus making it possible to further increase heat-exchange efficiency. It should be noted that the depressed grooves 51cs . . . on the cooling unit 3c side can also be configured (formed) in the same manner as the abovementioned heating unit 3h side. This makes it possible to advance the cooling starting timing, in addition to increasing the actual surface area with the corrugated surfaces on the cooling unit 3c side, too, thus making it possible to further increase heat-exchange efficiency.

Although FIG. 16 exemplifies a case where the depressed grooves 51hs . . . are identical in groove width to each other and are placed at regular intervals, the depressed grooves 51hs . . . may be different in groove width from each other and be placed at different intervals. The same applies to the other depressed grooves 51cs . . . . In addition, even in the case of the modification shown in FIG. 16, the auxiliary spaces 9hi, 9he, 9ci, and 9ce may be provided in the same manner. Of course, the auxiliary spaces 9hi, 9he, 9ci, and 9ce may or may not be provided.

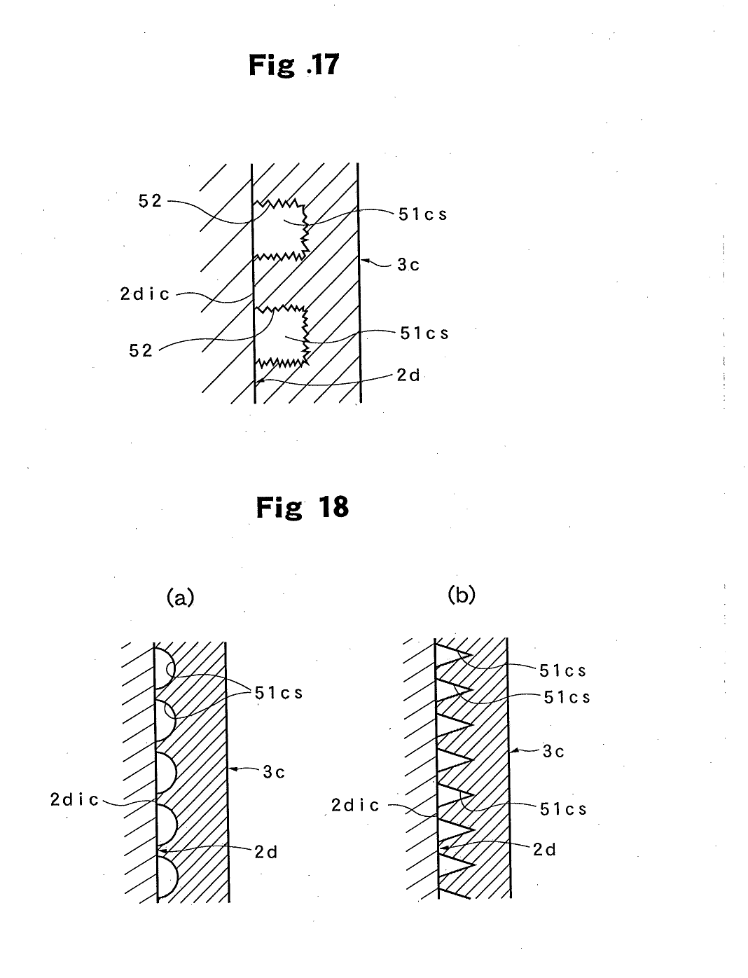

Further, FIGS. 17 and 18 show modifications each obtained by further modifying a part of the modification shown in FIG. 16. In FIG. 17, some or all of the inner surfaces 52 of the depressed grooves 51cs . . . (same applies to the depressed grooves 51hs and the common depressed grooves 51ha and 51hb) shown in FIG. 16 are formed as two-dimensional corrugated surfaces. This makes it possible to further increase the actual heat-transfer area between the heating and/or cooling unit(s) 3h . . . and/or 3c . . . and the working gas G, thus making it possible to contribute to further improvement in heat-exchange efficiency. Meanwhile, FIG. 18 shows a modification of the cross-sectional shape of each of the depressed grooves 51cs . . . . FIG. 18(a) shows an example where the cross-sectional shape of each of the depressed grooves 51cs is a semicircular shape, and FIG. 18(b) shows an example where the cross-sectional shape of each of the depressed grooves 51cs is a triangular shape. Thus, the cross-sectional shapes of each of the depressed grooves 51cs can be any of various types of shapes formed in consideration of processability (manufacturability) and the like. Furthermore, although, in the case thus exemplified, the corrugated surfaces (such as the depressed grooves 51hs . . . ) are directly formed on the inner circumferential surfaces 2dih and 2dic, the corrugated surfaces can be similarly configured (shaped) by incorporating separately-formed components.

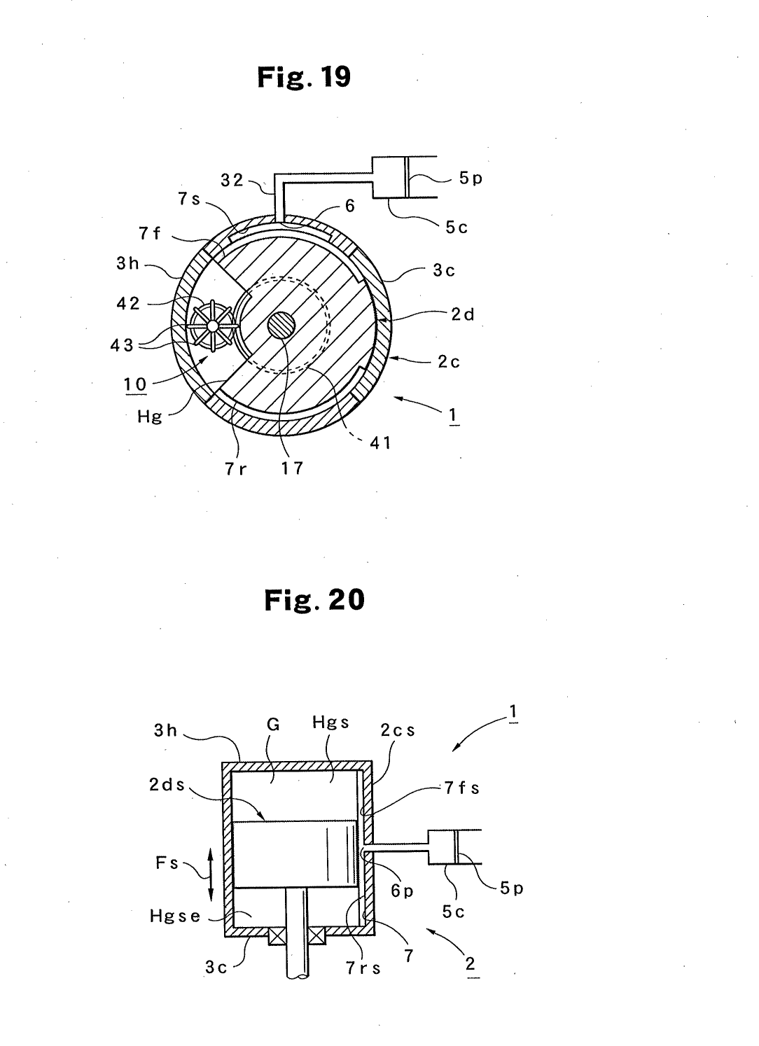

The modified embodiment shown in FIG. 19 differs from the basic embodiment shown in FIG. 1 in that the displacer 2d is additionally provided with a stirring mechanism 10 that stirs the content of the gas retention space Hg. The stirring mechanism 10 thus exemplified includes a transmitting gear 41 coaxially fixed with respect to the displacer 2d, a receiving gear 42 rotatably disposed inside of the gas retention space Hg, and a plurality of fins 43 . . . fixed to the receiving gear 42. With this, rotation of the displacer 2d causes the transmitting gear 41 to rotate, and this rotation of the transmitting gear 41 causes the receiving gear 42, and by extension the fins 43 . . . , to rotate. As a result, this rotation of the fins 43 . . . causes the working gas G in the gas retention space Hg to be stirred. This makes it possible to contribute to further improvement in heat conversion efficiency.

The modified embodiment shown in FIG. 20 is one in which, in configuring the displacer body unit 2, the displacer body unit 2 is provided with a linear displacer 2ds that has a circular cylindrical shape and is displaced forward and backward in the axial direction Fs and a displacer cylinder 2cs whose inner circumferential surface is provided with a gas passageway 7 extending along the axial direction Fs. With this, repetitive displacement of the displacer 2ds in the axial direction Fs by an actuator (not illustrated) allows the Stirling engine 1 to operate. That is, in the case thus exemplified, an upper end face of the displacer cylinder 2cs is heated as the heating unit 3h, and a lower end face of the displacer 2cs is cooled as the cooling unit 3c. Then, when the displacer 2ds is displaced toward the lower end, a gas retention space Hgs appears on the upper side and is heated by the heating unit 3h, so that the working gas G in the gas retention space Hgs expands. The portion of the gas G having thus expanded in volume acts on the power cylinder 5c via a front passageway 7fs and a working gas inlet/outlet 6p to cause the power piston 5p to move in such a direction as to project. On the other hand, when the displacer 2ds is displaced toward the upper end, a gas retention space Hgse appears on the lower side and is cooled by the cooling unit 3c, so that the working gas G in the gas retention space Hgse contracts. The portion of the gas G having thus contracted in volume acts on the power cylinder 5c via a rear passageway 7rs and the working gas inlet/outlet 6p to cause the power piston 5p to move in such a direction as to retract. Thus, even when the Stirling engine 1 uses the linear displacer 2ds, the Stirling engine 1 can bring about certain working effects based on the gas passageway 7 provided according to the present invention. It should be noted that, in FIGS. 1 to 20, components that are identical in basic configuration are given the same reference numeral, and the configuration is clarified.

In the foregoing, the best embodiment (and the modified embodiments) has/have been described in detail. However, the present invention is not limited to these embodiments. The configurations, shapes, materials, numbers, techniques, and the like of details can be freely modified, added, or deleted, provided such modifications, additions, and deletions do not depart from the gist of the present invention.

For example, although, in the basic embodiment shown in FIG. 1, the cylinder body 11 is configured by a combination of four panel members equally divided in a circumferential direction, the panel members can be divided or combined in any fashion or manner, and this is not intended to exclude a case where the cylinder body 11 is integrally formed. Further, although a case where the working gas inlet/outlet 6 is disposed in substantially the middle of the upper heat-insulting panel 13u in the axial direction Fs and the circumferential direction Ff has been exemplified, the working gas inlet/outlet 6 may alternatively be disposed in any selected position in the cylinder body 11. Therefore, the position in which the gas passageway 7 is provided can be any position that corresponds to the position of the working gas inlet/outlet 6. It should be noted that, instead of providing one gas passageway 7 (front passageway 7f, rear passageway 7r) in the axial direction Fs, it is possible to provide a plurality of gas passageways 7 at predetermined intervals or dispose the front passageway 7f and the rear passageway 7r to be offset relative to each other in the axial direction Fs. Furthermore, although examples where one or two working gas inlet/outlets 6 (6e, 6p) are provided have been shown, three or more working gas inlet/outlets may alternatively be provided. On the other hand, the inner circumferential surface which is formed by a corrugated surface to enlarge the actual surface area may be provided only on either 2dih or 2dic, and one or two among the auxiliary spaces 9hi, 9he, 9ci, and 9ce may be selectively provided. Meanwhile, the clearance adjustment mechanisms 8x . . . , the position adjustment mechanisms 8y . . . , and the stirring mechanism 10 may be replaced by other various types of components, provided such components can fulfill the same functions. In addition, although the rotary generator 33, which rotates the rotation input shaft 33s via the crank mechanism 34, has been exemplified, it may be replaced by a linear generator that enables direct input of a motion of the power piston 5p. Further, although a case has been shown where the electric motor 21 is used as the driving actuator 4, this is not intended to exclude a configuration in which the rotation output of the crank mechanism connected to the power piston 5p is directly transmitted via a mechanical transmission mechanism to the displacer 2d.

### INDUSTRIAL APPLICABILITY

A Stirling engine according to the present invention can be used for various purposes as various types of power sources, such as the exemplified purpose of generating electricity. In particular, the Stirling engine is not bound by its name, and is a concept that encompasses various types of heat engine whose principles are the same or similar and to which the present invention can be applied.

The invention claimed is:

1. A Stirling engine comprising:
a displacer body unit having a displacer cylinder in which a working gas and a movable displacer are accommodated;
a cooling and heating working unit having a heating unit that heats a first side of the displacer cylinder and a cooling unit that cools a second side of the displacer cylinder;
a displacer-driving actuator that moves the displacer; and
a power output unit having a power cylinder containing a power piston that is moved by an effect of volume change of the working gas in the displacer cylinder,
wherein the displacer has a gas retention space formed therein, the gas retention space enabling the working gas to be alternately moved between a heating unit side and a cooling unit side of the displacer cylinder by movement of the displacer,
the displacer and the displacer cylinder have an outer circumferential surface and an inner circumferential surface, respectively, formed into such shapes as to be able to permit the movement of the displacer and inhibit passage of the working gas, and
the displacer has a gas passageway formed on its outer circumferential surface, including a gas passage groove which allows the gas retention space to communicate with a working gas inlet/outlet provided in the displacer cylinder and connected to the power cylinder.

2. The Stirling engine according to claim 1, wherein the displacer body unit includes a precisely circular cylindrical rotary displacer whose outer circumferential surface is parallel to an axial direction with respect to a central axis on which the displacer rotates and whose gas retention space is formed by notching a part of the outer circumferential surface, and
the heating unit and the cooling unit are disposed in 180-degree opposed positions, respectively, on an outer surface of the displacer cylinder in a radial direction.

3. The Stirling engine according to claim 1, wherein the gas passageway is constituted by a front passageway extending from a first end of the gas retention space in a circumferential direction along the circumferential direction of the displacer and a rear passageway extending from a second end of the gas retention space in the circumferential direction along the circumferential direction of the displacer, and
the front passageway and the rear passageway are formed as discontinuous passageways that are independent of each other.

4. The Stirling engine according to claim 1, wherein the gas passageway is constituted by a front passageway extending from a first end of the gas retention space in a circumferential direction along the circumferential direction of the displacer and a rear passageway extending from a second end of the gas retention space in the circumferential direction along he circumferential direction of the displacer, and
the front passageway and the rear passageway are formed as continuous passageways that communicate with each other.

5. The Stirling engine according to claim 1, wherein the displacer cylinder has one or two or more of these working gas inlet/outlets.

6. The Stirling engine according to claim 1, wherein the displacer cylinder has an auxiliary gas passageway formed on a part of the inner circumferential surface that faces the working gas inlet/outlet and including a gas passage groove communicating with the gas passageway across a predetermined range of angles in the circumferential direction.

7. The Stirling engine according to claim 1, wherein the displacer body unit includes clearance adjustment mechanisms that are capable of adjusting clearances between both end faces of the displacer and inner surfaces of ends of the displacer cylinder.

8. The Stirling engine according to claim 1, wherein the displacer body unit includes a rotary displacer whose outer circumferential surface is tapered with respect to a central axis on which the displacer rotates and whose gas retention space is formed by notching a part of the outer circumferential surface,
the heating unit and the cooling unit are disposed in 180-degree opposed positions, respectively, on an outer surface of the displacer cylinder in a radial direction, and
the displacer body unit includes position adjustment mechanisms that are capable of adjusting the position of the displacer in an axial direction with respect to the displacer cylinder.

9. The Stirling engine according to claim 1, wherein the inner circumferential surface of the displacer cylinder includes an inner circumferential surface(s) corresponding to the heating unit and/or the cooling unit and is formed as a corrugated surface(s) to enlarge the actual surface area.

10. The Stirling engine according to claim 9, wherein the corrugated surface(s) is/are formed by a plurality of depressed grooves placed at predetermined intervals in an axial direction and extending along a circumferential direction.

11. The Stirling engine according to claim 10, wherein some or all of the depressed grooves have their inner surfaces formed as two-dimensional corrugated surfaces.

12. The Stirling engine according to claim 1, wherein the inner circumferential surface of the displacer cylinder includes an inner circumferential surface(s) corresponding to the heating unit and/or the cooling unit and provided with an auxiliary space(s) formed by notching a first end side and/or a second end side of the displacer cylinder in a circumferential direction.

13. The Stirling engine according to claim 1, wherein the displacer includes a stirring mechanism that stirs the content of the gas retention space.

14. The Stirling engine according to claim 1, wherein the displacer body unit includes a linear displacer that has a circular cylindrical shape and is displaced forward and backward in an axial direction,
the gas passageway is provided in the inner circumferential surface of the displacer cylinder and/or the outer circumferential surface of the displacer and extends in the axial direction,
the gas retention space is provided between inner surfaces of an end face of the displacer and an end face of the displacer cylinder, and
the heating unit and the cooling unit are disposed on outer surfaces of end faces of the displacer cylinder in the axial direction, respectively.

15. The Stirling engine according to claim 2, wherein the gas passageway is constituted by a front passageway extending from a first end of the gas retention space in a circumferential direction along the circumferential direction of the displacer and a rear passageway extending from a second end of the gas retention space in the circumferential direction along the circumferential direction of the displacer, and
the front passageway and the rear passageway are formed as discontinuous passageways that are independent of each other.

16. The Stirling engine according to claim 2, wherein the gas passageway is constituted by a front passageway extending from a first end of the gas retention space in a circumferential direction along the circumferential direction of the displacer and a rear passageway extending from a second end of the gas retention space in the circumferential direction along he circumferential direction of the displacer, and
the front passageway and the rear passageway are formed as continuous passageways that communicate with each other.

17. The Stirling engine according to claim 5, wherein the displacer cylinder has an auxiliary gas passageway formed on a part of the inner circumferential surface that faces the working gas inlet/outlet and including a gas passage groove communicating with the gas passageway across a predetermined range of angles in the circumferential direction.

18. The Stirling engine according to claim 2, wherein the displacer body unit includes clearance adjustment mechanisms that are capable of adjusting clearances between both end faces of the displacer and inner surfaces of ends of the displacer cylinder.
